(19) United States
(12) Patent Application Publication
(10) Pub. No.: US 2016/0182311 A1
(43) Pub. Date: Jun. 23, 2016

(54) METHOD, SYSTEMS, MEDIA, AND PLATFORMS FOR IMPROVED WORKFLOW MANAGEMENT

(71) Applicant: TAGATOO, INC., San Francisco, CA (US)

(72) Inventor: Amir BORNA, San Francisco, CA (US)

(21) Appl. No.: 14/578,165

(22) Filed: Dec. 19, 2014

(51) Int. Cl. H04L 12/24; G06Q 10/06; H04L 12/58; G06Q 10/10

(52) U.S. Cl. CPC H04L 41/50; G06Q 10/1095; G06Q 10/063114; H04L 51/08

(57) ABSTRACT

The computer-implemented electronic communication systems, methods, media and platforms improve electronic communication based workflow management by providing a software generating module to generate an electronic communication comprising a tag, a software receiving module configured to receive the electronic communication, a software responding module configured to respond to the electronic communication, whereby using the computer-implemented electronic communication systems, methods, media and platforms to generate the electronic communication, receive the electronic communication, and respond to the electronic communication improves electronic communication based workflow management.

### BACKGROUND OF THE INVENTION

A collaborative information management system affords more efficient and informed communications. Management of collaborative information by categorizing and/or classifying electronic communications, for example tagging, provides at least one aspect to enhance collaborative communications. Collaborative communications comprise electronic communications, emails, text messages, voice messages, and other types of electronic media based messages.

### SUMMARY OF THE INVENTION

Traditional communication systems, for example email systems, provide limited ability for system based classification of e-mails that afford efficient and informed collaborative communication. For example, traditional email systems are configured to permit a sender or recipient of an email to assign a flag or other importance indicator to the e-mail. While this indicates the email as being important, the flag or other importance indicator does not impose a system based urgency on the email or on a response or action that is required based on the email. The inventor of the subject matter described herein, provides systems, methods, media, and platforms that afford tags to be assigned to electronic communications, for example emails that impose a system based type and urgency on the email or on a response or action that is required based on the email.

Traditional communication systems, for example email systems, provide options for email recipients to filter received emails based on content and/or metadata of the received email. However, if the recipient uses a broad filter, a large number of emails will be received thus rendering the filter relatively useless. Alternatively, a recipient using a narrow filter will receive a smaller number of emails, however the recipient will not receive one or more emails that are of high importance, relatively high importance, high urgency, or relatively high urgency. For example, an email recipient that attempts to block spam using a personal filter can also block email the recipient would like to receive, and/or let undesired spam enter the recipient's e-mail system. The inventor of the subject matter described herein, provides systems, methods, media, and platforms in which sender generated tags are used to filter types of received communications, for example requests for action, task, inquiry and/or FYI communications such that filtering is more efficient.

Traditional communication systems, for example email systems, provide options to set a task for an email recipient. However, such systems provide limited task assignment and thus are not useful for collaborative communication management. For example, a task may be assigned to one recipient and may not be shared with others who would be interested in the status of the completion of the task. Moreover, a plurality of tasks cannot be delegated from a single communication indicating a request for action. The inventor of the subject matter described herein, provides systems, methods, media, and platforms that afford efficient and collaborative task assignment by tagging communications, for example a request for action communication comprising a task.

The inventor of the subject matter described herein, provides systems, methods, media, and platforms that provide system based classification of communications in both synchronous and asynchronous communication systems to permit senders to set the system based classifications of communications, and to permit recipients via the recipient's communication system to organize, filter, and/or take action based on the system classifications of communications set by a sender and imposed by the communication system.

In some aspects, provided herein are computer-implemented systems, methods, media and platforms for improving electronic communication based workflow management comprising a client processor configured to provide a client application comprising: a software generating module configured to provide a compose interface configured to receive user input to generate a communication life cycle by composing an electronic communication and assigning the electronic communication one or more tags from a plurality of tags, wherein a first tag indicates a request for action and a second tag indicates an FYI, wherein the compose interface comprises one or more interface elements that tag and send the electronic communication to a recipient, and wherein the one or more tags are stored in electronic communication metadata; a software receiving module configured to receive the electronic communication, identify an electronic communication type based on the electronic communication metadata, and provide a receipt interface comprising a first interface element corresponding to the first tag and a second interface element corresponding to the second tag, wherein selection of the first interface element displays only a request for action electronic communication and selection of the second interface element displays only an FYI electronic communication; and a software responding module configured to provide an interface to respond to the electronic communication, wherein a response to the request for action electronic communication comprises one or more of accepting the request for action, declining the request for action, a response to the request for action, a delegation of the request for action, and a percent complete, and wherein a response to the FYI electronic communication requires generation of another communication life cycle; whereby using the computer-implemented electronic communication system to generate the electronic communication, receive the electronic communication, and respond to the electronic communication improves electronic communication based workflow management.

In some embodiments, the computer-implemented systems, methods, media and platforms for improving electronic communication based workflow management further comprise a server comprising a store and a server processor configured to provide a server application comprising: a software receiving module configured to receive and store the electronic communication; a software parsing module configured to parse and store the electronic communication metadata, wherein the metadata comprises the tag and one or more of: identification information of a user sending the electronic communication, identification information of a user receiving the electronic communication, a request for action due date, a request for action completion date, a dependency between more than one request for action, and a dependency between more than one user; a software updating module configured to update the communication life cycle when the response to the request for action electronic communication is sent, the response comprising one or more of the delegation of the request for action and the percent complete, and wherein the update is stored in the electronic communication metadata; and a software transmitting module configured to transmit the updated electronic communication metadata to the client processor.

In some embodiments of the computer-implemented systems, methods, media and platforms for improving electronic communication based workflow management, the electronic communication type comprises one or more of a request for action, a task, a ToDo, an inquiry, a request for information, and an FYI. In some embodiments of the computer-implemented systems, methods, media and platforms for improving electronic communication based workflow management, the electronic communication comprises an email, a text message, an instant message, or a voice message.

In some embodiments of the computer-implemented systems, methods, media and platforms for improving electronic communication based workflow management, the system is configured to be run using a mobile device comprising a cellular phone, a smart phone, a tablet computer, and a smart watch.

In some embodiments of the computer-implemented systems, methods, media and platforms for improving electronic communication based workflow management, the client application comprises a software selecting module configured to provide a due date selection interface. In some embodiments of the computer-implemented systems, methods, media and platforms for improving electronic communication based workflow management, the client application comprises a software selecting module configured to provide a reminder interface configured to allow a sender of an electronic communication to set a reminder date for a sent electronic communication. In some embodiments of the computer-implemented systems, methods, media and platforms for improving electronic communication based workflow management, the client application comprises a software displaying module configured to provide an interface to display one or more due items, and wherein the one or more due items are displayed with corresponding due dates. In some embodiments of the computer-implemented systems, methods, media and platforms for improving electronic communication based workflow management, the interface to display due items is a calendar, a grid, or a list.

In some embodiments of the computer-implemented systems, methods, media and platforms for improving electronic communication based workflow management, a sender and a recipient of an electronic communication are the same user.

In some embodiments of the computer-implemented systems, methods, media and platforms for improving electronic communication based workflow management, the client application comprises a software overlaying module configured to provide an FYI overlay comprising one or more of i) an interface element to like the electronic communication, ii) an interface element to mark the electronic communication as useful, iii) an interface element to snooze the electronic communication, iv) an interface element to respond to the electronic communication v) an interface element to forward the electronic communication, vi) an interface element to generate a Self ToDo based on the electronic communication, vii) an interface element to delete the electronic communication viii) an interface element to mute the electronic communication, or ix) an interface element to archive the electronic communication, and wherein based on the selection of an interface element the electronic communication metadata is updated or another interface is presented.

In some embodiments of the computer-implemented systems, methods, media and platforms for improving electronic communication based workflow management, the client application comprises a software overlaying module configured to provide an inquiry response overlay comprising one or more of i) an interface element to indicate a recipient will soon answer the inquiry, ii) an interface element to indicate a recipient does not know the answer, iii) an interface element to snooze the electronic communication, iv) an interface element to respond to the electronic communication, v) an interface element to delegate the electronic communication, vi) an interface element to generate a Self ToDo based on the electronic communication, vii) an interface element to delete the electronic communication, viii) an interface element to mute the electronic communication, or ix) an interface element to archive the electronic communication, and wherein based on the selection of an interface element the electronic communication metadata is updated or another is interface is presented. In some embodiments of the computer-implemented systems, methods, media and platforms for improving electronic communication based workflow management, selection of the interface element to indicate a recipient does not know the answer presents a quick answer overlay comprising an interface to select a prepared response, and wherein selection of the prepared response sends a response electronic communication. In some embodiments of the computer-implemented systems, methods, media and platforms for improving electronic communication based workflow management, selection of the interface element to snooze the electronic communication presents a snooze overlay comprising an interface to select a snooze date or a snooze time, and wherein selection of the snooze date or the snooze time updates the electronic communication metadata.

In some embodiments of the computer-implemented systems, methods, media and platforms for improving electronic communication based workflow management, the client application comprises a software overlaying module configured to provide a task response overlay comprising one or more of i) an interface element to accept the task, ii) an interface element to decline the task, iii) an interface element to add a reminder to the task, iv) an interface element to set a due date for the task, v) an interface element to delegate the task, vi) an interface element to update the progress of completing the task, vii) an interface element to delete the task, viii) an interface element to add a watcher to the task, ix) an interface element to archive the electronic communication, and the electronic communication metadata is updated or another is interface is presented when the user selects an interface element. In some embodiments of the computer-implemented systems, methods, media and platforms for improving electronic communication based workflow management, selection of the accept the task interface element presents a quick accept overlay comprising an interface to select a prepared response, and wherein selection of a prepared response sends a response electronic communication. In some embodiments of the computer-implemented systems, methods, media and platforms for improving electronic communication based workflow management, selection of the interface element to decline the task presents a quick decline overlay comprising an interface to select a prepared response, and wherein selection of a prepared response sends a response electronic communication. In some embodiments of the computer-implemented systems, methods, media and platforms for improving electronic communication based workflow management, selection of the interface element to update the progress of completing the task presents a progress update overlay comprising an interface to select a percent complete, and wherein selection of the percent complete updates the electronic communication metadata. In some embodiments of the computer-implemented systems, methods, media and platforms for improving electronic communication based workflow management, selection of the interface element to set a due date presents a set a due date overlay comprising an interface to select the due date by a recipient, and wherein selection of the date updates the electronic communication metadata.

In some embodiments of the computer-implemented systems, methods, media and platforms for improving electronic communication based workflow management, the client application comprises a software displaying module configured to provide a chart interface, wherein the chart interface is configured to display a graphical representation of the communication life cycle. In some embodiments of the computer-implemented systems, methods, media and platforms for improving electronic communication based workflow management, the graphical representation comprises a sent request for action electronic communication, the delegation of the request for action, and the percent complete of the request for action.

In some embodiments of the computer-implemented systems, methods, media and platforms for improving electronic communication based workflow management the client application is further configured to provide a thread interface, wherein the thread interface is configured to display a graphical representation of the contents of a communication life cycle. In some embodiments of the computer-implemented systems, methods, media and platforms for improving electronic communication based workflow management, the contents of the communication life cycle comprises a sent task electronic communication, a delegation of the task, and a percent completion of the task.

In some embodiments of the computer-implemented systems, methods, media and platforms for improving electronic communication based workflow management, the client application is further configured to provide a message interface configured to provide a selectable interface element to allow receipt of a sent electronic communication from a sender or to always allow receipt of a sent electronic communication from a sender. In some embodiments of the computer-implemented systems, methods, media and platforms for improving electronic communication based workflow management, receipt of the electronic communication is set based on preset values for a group and/or an organization.

In some embodiments of the computer-implemented systems, methods, media and platforms for improving electronic communication based workflow management, the client interface comprises a software module configured to provide a support interface, wherein the support interface comprises a selectable interface element configured to tag and send the electronic communication as an FYI, an inquiry or a task, and wherein the FYI is a bug report, the inquiry is a question, and the task is a feature request.

In some embodiments of the computer-implemented systems, methods, media and platforms for improving electronic communication based workflow management, the client application comprises a software module configured to notify the user when the electronic communication is received, the notification comprising audible notification, tactile notification, or audible and tactile notification. In some embodiments of the computer-implemented systems, methods, media and platforms for improving electronic communication based workflow management, the notification is provided when a quick response is required by the electronic communication. In some embodiments of the computer-implemented systems, methods, media and platforms for improving electronic communication based workflow management, the recipient selects one or more electronic communication types for which notification is provided. In some embodiments, the electronic communication type comprises one or more of a request for action, a task, a ToDo, an inquiry, a request for information, and an FYI. In some embodiments of the computer-implemented systems, methods, media and platforms for improving electronic communication based workflow management notification is provided when an inquiry electronic communication is received. In some embodiments of the computer-implemented systems, methods, media and platforms for improving electronic communication based workflow management notification is provided when a quick reply is required by the electronic communication. In some embodiments of the computer-implemented systems, methods, media and platforms for improving electronic communication based workflow management notification is provided when a task electronic communication is received and the task electronic communication comprises a due date within a time period. In some embodiments of the computer-implemented systems, methods, media and platforms for improving electronic communication based workflow management the time period comprises one or more minutes, one or more hours, one or more days, one or more weeks, one or more months, or one or more years. In some embodiments of the computer-implemented systems, methods, media and platforms for improving electronic communication based workflow management the time period comprises 1 minute, 5 minutes, 10 minutes, 20 minutes, 30 minutes, 45 minutes, 1 hour, 2 hours, 6 hours, 12 hours, 1 day, 2 days, 3 days, 4 days, 5 days, 6 days, 1 week, 2 weeks, 3 weeks, 1 month, 2 months, 3 months, 4 months, 5 months, 6 months, 7 months, 8 months, 9 months, 10 months, 11 months, or one or more years.

In some embodiments of the computer-implemented systems, methods, media and platforms for improving electronic communication based workflow management, the client application comprises a software module configured to provide a sent interface comprising a first interface element corresponding to the first tag, a second interface element corresponding to the second tag, and a third interface element corresponding to the third tag, wherein selection of the first interface element displays only the electronic communication comprising a task tag, selection of the second interface element displays only the electronic communication comprising a request tag, and selection of the third interface element displays only the electronic communication comprising an FYI tag. In some embodiments of the computer-implemented systems, methods, media and platforms for improving electronic communication based workflow management, the sent interface comprises a software module configured to display a number of electronic communications tagged as an inquiry and the number of electronic communications tagged as a task. In some embodiments of the computer-implemented systems, methods, media and platforms for improving electronic communication based workflow management, the number of electronic communications that have not been opened by a recipient of the electronic communication are displayed. In some embodiments of the computer-implemented systems, methods, media and platforms for improving electronic communication based workflow management, the number of electronic communications that have not been completed are displayed. In some embodiments of the computer-implemented systems, methods, media and platforms for improving electronic communication based workflow management, the number of electronic communications that have been opened but have not been completed are displayed.

In some embodiments of the computer-implemented systems, methods, media and platforms for improving electronic communication based workflow management, the receipt interface comprises a software module configured to display a number of electronic communications that have not been opened are displayed. In some embodiments of the computer-implemented systems, methods, media and platforms for improving electronic communication based workflow management, the receipt interface comprises a software module configured to display a number of electronic communications that have not been completed are displayed. In some embodiments of the computer-implemented systems, methods, media and platforms for improving electronic communication based workflow management, the receipt interface comprises a software module configured to display a number of electronic communications that have been opened but have not been completed are displayed.

In some embodiments of the computer-implemented systems, methods, media and platforms for improving electronic communication based workflow management, the client application comprises a software module configured to provide a stats interface configured to display statistical information comprising the number of incomplete sent electronic communications tagged as an inquiry, the number of incomplete sent electronic communications tagged as a task, the number of incomplete received electronic communications tagged as an inquiry, the number of incomplete received electronic communications tagged as a task, the number of sent electronic communications tagged as an inquiry or tagged as task for which the completion deadline is within a time period, and the number of received electronic communications tagged as an inquiry or tagged as task for which the completion deadline is within a time period. In some embodiments of the computer-implemented systems, methods, media and platforms for improving electronic communication based workflow management, the system is configured to run on a personal computer, a laptop, a cellular phone, a smart phone, a smart watch, or a tablet computer. In some embodiments of the computer-implemented systems, methods, media and platforms for improving electronic communication based workflow management, the system, method, media and/or platform is an extension to an electronic communication application running on the computer. In some embodiments of the computer-implemented systems, methods, media and platforms for improving electronic communication based workflow management the system is a web browser extension, configured to interact with a web browser electronic communication application. In some embodiments of the computer-implemented systems, methods, media and platforms for improving electronic communication based workflow management the client application is a standalone application.

In some embodiments of the computer-implemented systems, methods, media and platforms for improving electronic communication based workflow management, the client application comprises a software displaying module configured to provide a due interface to the display the electronic communication comprising a due-date within a user-defined time period relative to the date in which the system promotes the electronic communication to the due interface, and wherein a plurality of electronic communications are displayed according to their completion deadline. In some embodiments of the computer-implemented systems, methods, media and platforms for improving electronic communication based workflow management, the user-defined time period is in the future or the past relative to the date in which the system promotes the electronic communication to the due interface. In some embodiments of the computer-implemented systems, methods, media and platforms for improving electronic communication based workflow management, a sent and a received electronic communication are displayed. In some embodiments of the computer-implemented systems, methods, media and platforms for improving electronic communication based workflow management, the time period is one day, two days, three days, one business week, one week, two weeks, three weeks, one month, two months, six months, or one year. In some embodiments of the computer-implemented systems, methods, media and platforms for improving electronic communication based workflow management, the time period is adjustable by the user.

In some embodiments of the computer-implemented systems, methods, media and platforms for improving electronic communication based workflow management, the compose interface is further configured to allow the user to select a watcher, wherein the watcher will receive the electronic communication, all replies to the electronic communications, and updates to the electronic communication. In some embodiments of the computer-implemented systems, methods, media and platforms for improving electronic communication based workflow management, the compose interface is configured to permit selection of the watcher after the electronic communication is sent.

In some aspects, the computer-implemented systems, methods, media and platforms for improving electronic communication based workflow management provided herein comprise a client processor configured to provide a client application comprising: a software generating module configured to provide a compose interface configured to receive user input to generate a communication life cycle by composing an electronic communication and assigning the electronic communication one or more tags from a plurality of tags, wherein a first tag indicates a task, a second tag indicates an inquiry, and a third tag indicates an FYI, wherein the compose interface comprises one or more interface elements that tag and send the electronic communication to a recipient, and wherein the one or more tags are stored in the metadata of the electronic communication; a software receiving module configured to receive the electronic communication, identify the electronic communication type based on the electronic communication metadata, and provide a receipt interface comprising a first interface element corresponding to the first tag, a second interface element corresponding to the second tag, and a third interface element corresponding to the third tag, wherein selection of the first interface element displays only a task electronic communication, selection of the second interface element displays only an inquiry electronic communication, and selection of the third interface element displays only an FYI electronic communication; and a software responding module configured to provide an interface to respond to the electronic communication, wherein a response to a task electronic communication comprises one or more of accepting the task, declining the task, indicating an amount completion of the task, and a delegation of the task to another recipient, and a percent complete, and wherein a response to an inquiry electronic communication comprises one or more of responding to the inquiry, forwarding the inquiry to another recipient, and deleting the inquiry, and wherein a response to an FYI electronic communication requires generation of another communication life cycle; whereby using the computer-implemented electronic communication system to generate the electronic communication, receive the electronic communication, and respond to the electronic communication improves electronic communication based workflow management.

In some embodiments, the computer-implemented systems, methods, media and platforms for improving electronic communication based workflow management further comprise a server comprising a store and a server processor configured to provide a server application comprising: a software storing module configured to receive and store the electronic communication; a software parsing module configured to parse and store the electronic communication metadata, wherein the metadata comprises the tag and one or more of: identification information of a user sending the electronic communication, identification information of a user receiving the electronic communication, a task due date, a task completion date, a dependency between more than one task, a dependency between more than one inquiry, and a dependency between more than one user; a software module configured to update the communication life cycle when the response to the task electronic communication is sent or the response to the inquiry electronic communication is sent, the response comprising one or more of the delegation of the task and the percent complete, and wherein the update is stored in the electronic communication metadata; and a software transmitting module configured to transmit the updated electronic communication metadata to the client processor.

In some aspects, the computer-implemented electronic communication system, methods, media and platforms for improving electronic communication based workflow management comprise a client processor configured to provide a client application comprising: a software receiving module configured to receive an electronic communication comprising one or more tags from a plurality of tags, wherein a first tag indicates a request for action and a second tag indicates an FYI, and identify an electronic communication type based on the electronic communication metadata; a software notification selection module, configured receive a notification selection from a recipient of an electronic communication, the notification selection indicating one or more electronic communication types for which notification is provided; and a software notifying module configured to notify a recipient when the electronic communication type is received, the notification comprising audible notification, tactile notification, or audible and tactile notification.

### INCORPORATION BY REFERENCE

All publications, patents, and patent applications mentioned in this specification are herein incorporated by reference to the same extent as if each individual publication, patent, or patent application was specifically and individually indicated to be incorporated by reference. Specifically, U.S. nonprovisional application Ser. No. 14/552,096, filed on Nov. 24, 2014, U.S. nonprovisional patent application Ser. No. 11/521,636 filed on Sep. 14, 2006, and U.S. provisional patent application 60/717,158, filed on Sep. 14, 2005, are hereby incorporated by reference.

### BRIEF DESCRIPTION OF THE DRAWINGS

FIG. 1 is an illustration of a non-limiting example of the platforms, systems, methods and computer readable media described herein, for example a login interface.

FIG. 2 is an illustration of a non-limiting example of the platforms, systems, methods and computer readable media described herein, for example a compose interface.

FIG. 3 is an illustration of a non-limiting example of the platforms, systems, methods and computer readable media described herein, for example an FYI communication life cycle.

FIG. 4 is an illustration of a non-limiting example of the platforms, systems, methods and computer readable media described herein, for example an inquiry communication life cycle.

FIG. 5 is an illustration of a non-limiting example of the platforms, systems, methods and computer readable media described herein, for example a task communication life cycle.

FIG. 6 is an illustration of a non-limiting example of the platforms, systems, methods and computer readable media described herein, for example a compose interface.

FIG. 7 is an illustration of a non-limiting example of the platforms, systems, methods and computer readable media described herein, for example an interface element to display support interface.

FIG. 8 is an illustration of a non-limiting example of the platforms, systems, methods and computer readable media described herein, for example a support interface.

FIG. 9 is an illustration of a non-limiting example of the platforms, systems, methods and computer readable media described herein, for example a support interface comprising one or more selectable interface elements configured to tag and send the electronic communication.

FIG. 10 is an illustration of a non-limiting example of the platforms, systems, methods and computer readable media described herein, for example an interface to turn on and off self ToDos.

FIG. 11 is an illustration of a non-limiting example of the platforms, systems, methods and computer readable media described herein, for example a Self ToDo interface to add a watcher.

FIG. 12 is an illustration of a non-limiting example of the platforms, systems, methods and computer readable media described herein, for example a Self ToDo interface to add a watcher.

FIG. 13 is an illustration of a non-limiting example of the platforms, systems, methods and computer readable media described herein, for example an overlay to enter a Self ToDo title.

FIG. 14 is an illustration of a non-limiting example of the platforms, systems, methods and computer readable media described herein, for example an interface element to display Out Open electronic communications.

FIG. 15 is an illustration of a non-limiting example of the platforms, systems, methods and computer readable media described herein, for example an interface to display Out Open electronic communications comprising an inquiry tag and/or a task tag.

FIG. 16 is an illustration of a non-limiting example of the platforms, systems, methods and computer readable media described herein, for example an interface to display Out Open electronic communications comprising an inquiry tag.

FIG. 17 is an illustration of a non-limiting example of the platforms, systems, methods and computer readable media described herein, for example an interface to display Out Open electronic communications comprising a task tag.

FIG. 18 is an illustration of a non-limiting example of the platforms, systems, methods and computer readable media described herein, for example a receipt interface.

FIG. 19 is an illustration of a non-limiting example of the platforms, systems, methods and computer readable media described herein, for example a chart interface.

FIG. 20 is an illustration of a non-limiting example of the platforms, systems, methods and computer readable media described herein, for example an interface element to display a receipt interface.

FIG. 21 is an illustration of a non-limiting example of the platforms, systems, methods and computer readable media described herein, for example a receipt interface comprising interface elements to display tagged communications.

FIG. 22 is an illustration of a non-limiting example of the platforms, systems, methods and computer readable media described herein, for example an interface to electronic communications comprising one or more tags.

FIG. 23 is an illustration of a non-limiting example of the platforms, systems, methods and computer readable media described herein, for example an interface to electronic communications comprising one or more tags.

FIG. 24 is an illustration of a non-limiting example of the platforms, systems, methods and computer readable media described herein, for example an interface to electronic communications comprising one or more tags.

FIG. 25 is an illustration of a non-limiting example of the platforms, systems, methods and computer readable media described herein, for example an interface to electronic communications comprising one or more tags.

FIG. 26 is an illustration of a non-limiting example of the platforms, systems, methods and computer readable media described herein, for example an interface element to display a due interface.

FIG. 27 is an illustration of a non-limiting example of the platforms, systems, methods and computer readable media described herein, for example a due interface.

FIG. 28 is an illustration of a non-limiting example of the platforms, systems, methods and computer readable media described herein, for example a due interface.

FIG. 29 is an illustration of a non-limiting example of the platforms, systems, methods and computer readable media described herein, for example a due interface comprising a calendar view.

FIG. 30 is an illustration of a non-limiting example of the platforms, systems, methods and computer readable media described herein, for example a stats interface.

FIG. 31 is an illustration of a non-limiting example of the platforms, systems, methods and computer readable media described herein, for example a stats interface.

FIG. 32 is an illustration of a non-limiting example of the platforms, systems, methods and computer readable media described herein, for example a menu interface element to display a Self ToDo interface.

FIG. 33 is an illustration of a non-limiting example of the platforms, systems, methods and computer readable media described herein, for example a Self ToDo interface.

FIG. 34 is an illustration of a non-limiting example of the platforms, systems, methods and computer readable media described herein, for example a Self ToDo interface.

FIG. 35 is an illustration of a non-limiting example of the platforms, systems, methods and computer readable media described herein, for example an interface element to display an FYI overlay.

FIG. 36A is an illustration of a non-limiting example of the platforms, systems, methods and computer readable media described herein, for example an FYI overlay.

FIG. 36B is an illustration of a non-limiting example of the platforms, systems, methods and computer readable media described herein, for example an FYI overlay.

FIG. 37 is an illustration of a non-limiting example of the platforms, systems, methods and computer readable media described herein, for example a quick reply overlay.

FIG. 38 is an illustration of a non-limiting example of the platforms, systems, methods and computer readable media described herein, for example an interface element to display an inquiry overlay.

FIG. 39 is an illustration of a non-limiting example of the platforms, systems, methods and computer readable media described herein, for example an inquiry overlay.

FIG. 40 is an illustration of a non-limiting example of the platforms, systems, methods and computer readable media described herein, for example a quick answer overlay.

FIG. 41 is an illustration of a non-limiting example of the platforms, systems, methods and computer readable media described herein, for example a snooze overlay.

FIG. 42 is an illustration of a non-limiting example of the platforms, systems, methods and computer readable media described herein, for example an interface element to display a task overlay.

FIG. 43 is an illustration of a non-limiting example of the platforms, systems, methods and computer readable media described herein, for example a task overlay.

FIG. 44 is an illustration of a non-limiting example of the platforms, systems, methods and computer readable media described herein, for example a quick accept overlay.

FIG. 45 is an illustration of a non-limiting example of the platforms, systems, methods and computer readable media described herein, for example an interface to edit quick reply responses.

FIG. 46 is an illustration of a non-limiting example of the platforms, systems, methods and computer readable media described herein, for example a quick decline overlay.

FIG. 47 is an illustration of a non-limiting example of the platforms, systems, methods and computer readable media described herein, for example a progress update overlay.

FIG. 48 is an illustration of a non-limiting example of the platforms, systems, methods and computer readable media described herein, for example a set due date overlay.

FIG. 49 is an illustration of a non-limiting example of the platforms, systems, methods and computer readable media described herein, for example a set personal reminder overlay.

FIG. 50 is an illustration of a non-limiting example of the platforms, systems, methods and computer readable media described herein, for example a New Composer.

FIG. 51 is an illustration of a non-limiting example of the platforms, systems, methods and computer readable media described herein, for example an Answer Composer.

FIG. 52 is an illustration of a non-limiting example of the platforms, systems, methods and computer readable media described herein, for example an Accept Composer.

FIG. 53 is an illustration of a non-limiting example of the platforms, systems, methods and computer readable media described herein, for example an Update Composer.

FIG. 54 is an illustration of a non-limiting example of the platforms, systems, methods and computer readable media described herein, for example a Simple Reply Composer.

### DETAILED DESCRIPTION OF THE INVENTION

### Generating Module

In some aspects, provided herein are systems, methods, media and platforms comprising a client processor configured to provide a client application comprising: a software generating module configured to provide a compose interface configured to receive user input to generate a communication life cycle by composing an electronic communication and assigning the electronic communication one or more tags from a plurality of tags, wherein a first tag indicates a request for action and a second tag indicates an FYI, wherein the compose interface comprises one or more interface elements that tag and send the electronic communication to a recipient, and wherein the one or more tags are stored in electronic communication metadata; a software receiving module configured to receive the electronic communication, identify the electronic communication based on the electronic communication metadata, and provide a receipt interface comprising a first interface element corresponding to the first tag and a second interface element corresponding to the second tag, wherein selection of the first interface element displays only a request for action electronic communication and selection of the second interface element displays only an FYI electronic communication; and a software responding module configured to provide an interface to respond to the electronic communication, wherein a response to the request for action electronic communication comprises one or more of accepting the request for action, declining the request for action, a response to the request for action, a delegation of the request for action, and a percent complete, and wherein a response to the FYI electronic communication requires generation of another communication life cycle.

In some aspects, provided herein are systems, methods, media and platforms comprising a client processor configured to provide a client application comprising: a software generating module configured to provide a compose interface configured to receive user input to generate a communication life cycle by composing an electronic communication and assigning the electronic communication one or more tags from a plurality of tags, wherein a first tag indicates a task, a second tag indicates an inquiry, and a third tag indicates an FYI, wherein the compose interface comprises one or more interface elements that tag and send the electronic communication to a recipient, and wherein the one or more tags are stored in the metadata of the electronic communication; a software receiving module configured to receive the electronic communication, identify the electronic communication type based on the electronic communication metadata, and provide a receipt interface comprising a first interface element corresponding to the first tag, a second interface element corresponding to the second tag, and a third interface element corresponding to the third tag, wherein selection of the first interface element displays only a task electronic communication, selection of the second interface element displays only an inquiry electronic communication, and selection of the third interface element displays only an FYI electronic communication; and a software responding module configured to provide an interface to respond to the electronic communication, wherein a response to a task electronic communication comprises one or more of accepting the task, declining the task, indicating an amount completion of the task, and a delegation of the task to another recipient, and a percent complete, and wherein a response to an inquiry electronic communication comprises one or more of responding to the inquiry, forwarding the inquiry to another recipient, and deleting the inquiry, and wherein a response to an FYI electronic communication requires generation of another communication life cycle. In some embodiments, the electronic communication type comprises one or more of a request for action, a task, a ToDo, an inquiry, a request for information, and/or an FYI.

In some embodiments, the electronic communication type is determined based on the metadata and/or the one or more tags assigned to the electronic communication. In some embodiments, the electronic communication type comprises one or more of a request for action, a task, a ToDo, an inquiry, a request for information, and/or an FYI. In some embodiments a request for action comprises a task and/or a ToDo. In some embodiments a request for action comprises an inquiry, a request for information, a task, and/or a ToDo. In some embodiments, the tag indicates one or more of a request for action, a task, a ToDo, a request for information, an inquiry, and an FYI.

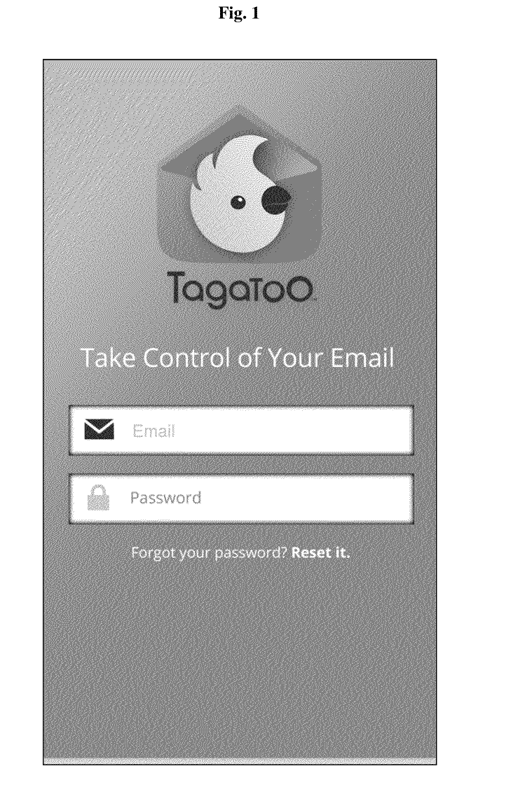

In some embodiments, as depicted in an illustration of a non-limiting example in FIG. 1, the computer-implemented electronic communication system for improving electronic communication based workflow management comprises a login interface. In some embodiments, the login interface comprises field configured to receive a user's email address and a field configured to receive a user's password associated with the email. In some embodiments, the computer-implemented electronic communication system for improving electronic communication based workflow management comprises other authorization methods, for example fingerprint verification, retina-scan identification, security code authorization methods, as well as other verification methods known to those skilled in the art.

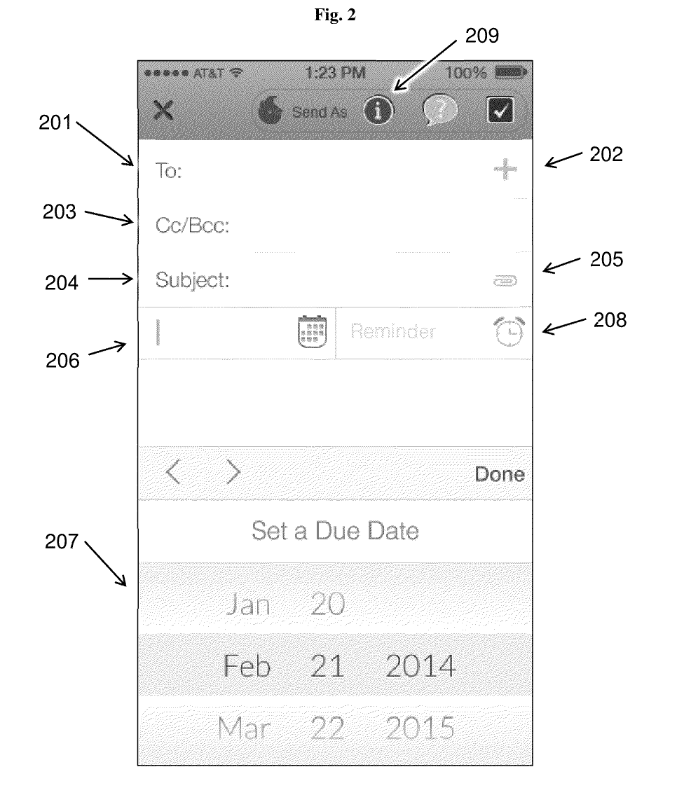

In some embodiments, as depicted in an illustration of a non-limiting example in FIG. 2, the computer-implemented electronic communication system for improving electronic communication based workflow management comprises a compose interface. In some embodiments, the compose interface comprises a filed (i.e., To: field) 201 to accept a recipients communication information, for example an email address. In some embodiments, the compose interface comprises an interface element 202 configured to provide a menu from which to select one or more recipients communication information. In some embodiments, the compose interface comprises a field (i.e., Cc/Bcc: field) 203 to accept a Cc'd or Bcc'd recipients communication information, for example an email address. In some embodiments, the compose interface comprises a field (i.e., Subject: field) 204 to accept a subject input by the composer of the communication. In some embodiments, the compose interface comprises an interface element 205 configured to allow a user to select documents to be attached to the communication. In some embodiments, the compose interface comprises a field 206 to receive a date, the date comprising a due date and/or a completion date. In some aspects, the sender inputs a due date and/or a reminder date and/or time to the electronic communication. In some embodiments, the systems, methods, media, and platforms described herein comprise a software selecting module configured to provide a due date selection interface. In some embodiments, selecting the field configured to receive a due date, displays the due date selection interface 207 such that a user can select the due date and/or the completion date. In some aspects, the systems, methods, media, and platforms described herein comprise a software selecting module configured to provide a reminder interface configured to allow a sender of an electronic communication to set a reminder date and/or time for an electronic communication. In some embodiments, the compose interface comprises a field 208 to display the reminder interface such that the sender can input a reminder date and/or a reminder time.

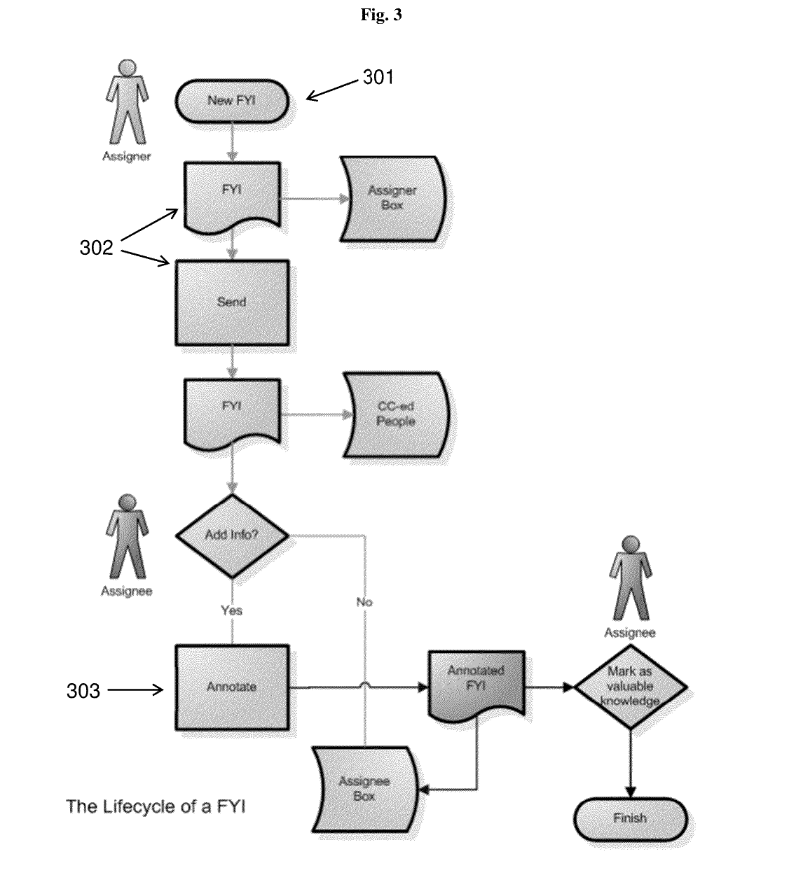

In some embodiments, a communication life cycle comprises an FYI communication life cycle. Depicted in FIG. 3 is an illustration of a non-limiting example of the platforms, systems, methods and computer readable media described herein, for example an FYI communication life cycle. The flow chart depicted in FIG. 3 is exemplary, and those of skill in the art will recognize various steps that might be added, deleted, and/or modified and are considered to be within the scope and purview of the present invention. In some embodiments, the order of the steps of the flow chart is different and such different arrangements are considered to be within the scope and purview of the present invention.

In some embodiments, an electronic communication tagged as an FYI shares information with recipients without expectation of replies or actions. In some embodiments, a recipient of an FYI adds his own notes to the message and adds it to his archive. In some embodiments, a reply to an FYI electronic communication starts a new communication life cycle. In some embodiments, the new communication life cycle is related to the originally started communication life cycle. In some embodiments, the recipient replying to the FYI electronic communication selects the same or different type of communication, for example by tagging the communication, e.g., FYI, inquiry, request for information, task, or request for action. In some embodiments a request for action comprises a task and/or a ToDo. In some embodiments a request for action comprises an inquiry, a request for information, a task, and/or a ToDo.

In some embodiments, a communication life cycle of an FYI is generated by composing an electronic communication 301, for example an email. In some embodiments, one or more recipients, one or more Cc'd persons, and/or one or more Bcc'd persons are included in the electronic communication. In some embodiments the sender of the electronic communication inputs a subject of the electronic communication. In some embodiments, the sender inputs a due date and/or a reminder date and/or time to the electronic communication. In some embodiments, one or more attachments are included in the communication. In some embodiments, at 302, the sender via an interface element 209 tags and sends the FYI communication.

In some embodiments, after receiving the electronic communication, a recipient annotates 303 the messages in the electronic communication. In some embodiments, the recipient changes and/or adds another tag to the electronic communication. For example, the recipient might tag the communication as a task and assign to himself or send to another user. In some embodiments a request for action comprises a task and/or a ToDo. In some embodiments a request for action comprises an inquiry, a request for information, a task, and/or a ToDo. In some embodiments, the recipient tags the electronic communication with a user defined classification, for example a tag to the email body or a portion thereof (e.g., one line of text might be tagged). In some embodiments, the recipient tags and sends the electronic communication to one or more additional recipients. In some embodiments, the tag is user-defined.

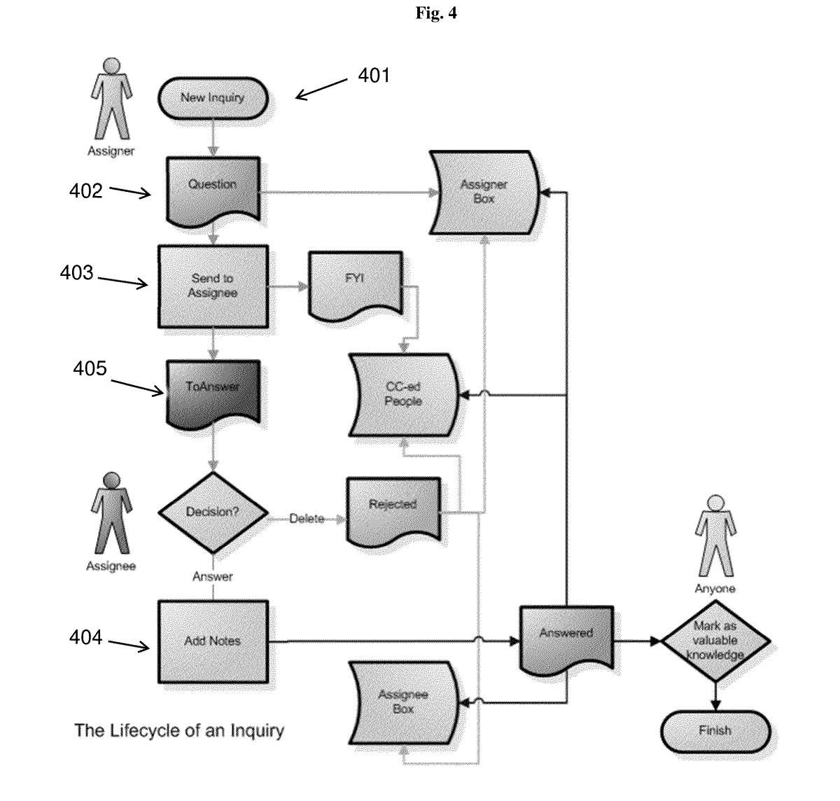

In some embodiments, a communication life cycle comprises an inquiry communication life cycle. Depicted in FIG. 4 is an illustration of a non-limiting example of the platforms, systems, methods and computer readable media described herein, for example an inquiry communication life cycle. The flow chart depicted in FIG. 4 is exemplary, and those of skill in the art will recognize various steps that might be added, deleted, and/or modified and are considered to be within the scope and purview of the present invention. In some embodiments, the order of the steps of the flow chart is different and such different arrangements are considered to be within the scope and purview of the present invention.

In some embodiments, an inquiry is sent to ask a question or request details. For example, an inquiry should not require actions to extensively gather information or involve time consuming efforts, however, in some embodiments the sender does not know the time required to reply to the inquiry. In some embodiments, an inquiry is sent when the recipient can reply quickly without doing time consuming work. In some embodiments, multiple users are assigned an inquiry, for example, by including multiple recipients in the To: field. In some embodiments, additional recipients are Cc'd and/or Bcc'd. In some embodiments, the Cc'd recipients and/or Bcc'd recipients are able to reply to the inquiry, however, recipient to whom the inquiry is assigned should answer the inquiry to close the communication life cycle. In some embodiments, the sender of the electronic communication closes the communication life cycle, for example, when the sender receives the required information and/or the request for action is complete. In some embodiments, when the recipient to whom the inquiry is assigned answers the inquiry, the Cc'd and/or Bcc'd recipient receive FYI electronic communications comprising the response to the inquiry.

In some embodiments, a sender composes an electronic communication 401, for example an email. In some embodiments, text is included in the electronic communication, the text comprising an inquiry. In some embodiments, one or more recipients, one or more Cc'd persons, and/or one or more Bcc'd persons are included in the electronic communication. In some embodiments the sender of the electronic communication inputs a subject of the electronic communication. In some embodiments, the sender inputs a due date and/or a reminder date and/or time to the electronic communication. In some embodiments, the due date is the date by which the recipient of the electronic communication should respond to the inquiry. In some embodiments, when the sender Cc's and/or Bcc's additional recipients, the electronic communication is tagged as FYI for the additional recipients. In some embodiments, at 402, the sender via an interface element 209 tags and sends the inquiry communication.

In some embodiments one or more recipients receive the electronic communication 403. In some embodiments, a recipient who received the electronic communication annotates 404 the inquiry in the electronic communication. In some embodiments, the recipient changes the tag of the electronic communication, for example, the recipient changes the electronic communication from an inquiry to a Self ToDo and/or a task for himself and/or another recipient and/or another user of the system. In some embodiments, the recipient assigns an additional user defined tag, for example a tag to a portion the electronic communication (e.g., one line of text might be tagged). In some embodiments, the recipient assigns a time limit to the electronic communication. For example, the time limit is a read-by time, a time limit associated with a task and/or an inquiry. In some embodiments, the recipient sends the electronic communication to one or more additional recipients and/or one or more additional users. In some embodiments, the recipient tags the electronic communication with one or more additional tags and/or one or more user-defined tags.

In some embodiments, the recipient replies 405 to the electronic communication. For example, the recipient responds to the inquiry. As another example, the recipient deletes the electronic communication, in which case a server is configured to send an additional electronic communication to the sender and/or update the metadata of the original electronic communication to indicate the inquiry has been deleted, i.e., rejected. In some embodiments, the updated metadata is communicated to the sender and the one or more additional recipients. In some embodiments, the additional electronic communication is sent to the sender and/or one or more additional recipients of the original electronic communication. In some embodiments, to indicate the inquiry is rejected an additional electronic communication is not sent, but rather a tag is added to the original communication that shows the inquiry was rejected.

In some embodiments, an inquiry comprises a question and/or requests other information that does not require significant action to be performed by the recipient of the electronic communication. In some embodiments, inquiries do not require the recipient of the request to gather information or involve time consuming efforts. In some embodiments, a sender of an inquiry electronic communication does not know how much time is required for the recipient to provide the requested information. In some embodiments, multiple recipients are assigned the inquiry, for example by including multiple recipients on the To list of the electronic communication. In some embodiments, recipients of an inquiry who are CC'd or BCC'd receive the electronic communication as an FYI. In some embodiments, deleting the electronic communication by the recipient indicates the inquiry is rejected. In some embodiments, the system sends an additional communication to the sender of an inquiry and, if included on the originally sent electronic communication, other recipients who were CC'd and/or BCC'd. In some embodiments, an additional electronic communication is not sent but the metadata of the electronic communication is updated and/or the electronic communication is tagged as rejected.

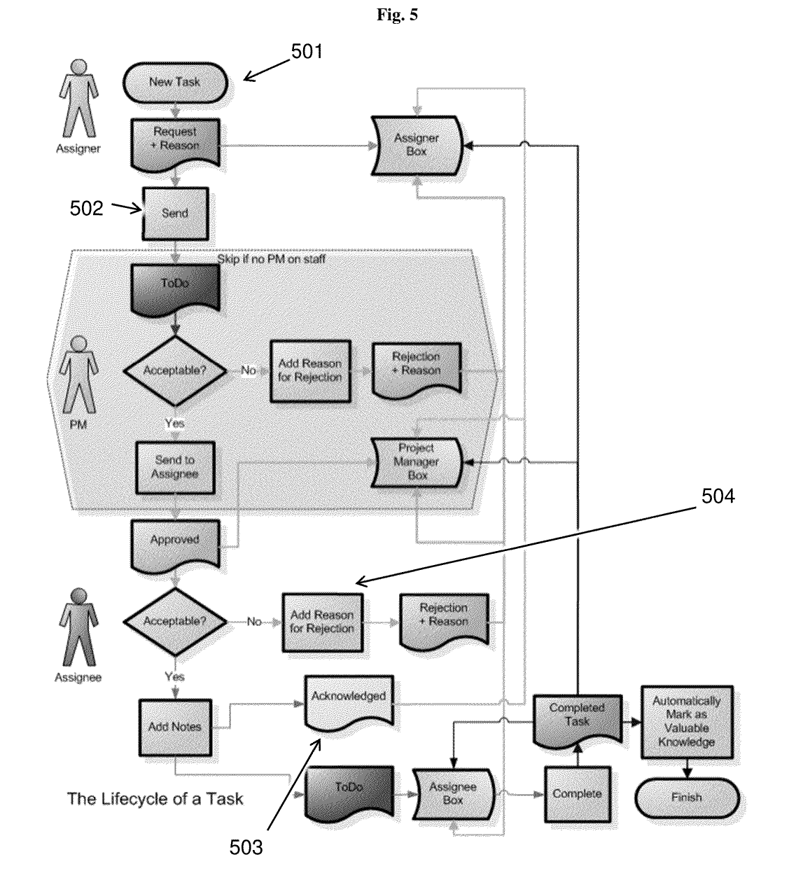

In some embodiments, a communication life cycle comprises a task communication life cycle. Depicted in FIG. 5 is an illustration of a non-limiting example of the platforms, systems, methods and computer readable media described herein, for example a task communication life cycle. The flow chart depicted in FIG. 5 is exemplary and those of skill in the art will recognize various steps that might be added, deleted, and/or modified and are considered to be within the scope and purview of the present invention. In some embodiments, the order of the steps of the flow chart is arranged differently and is considered to be within the scope and purview of the present invention. The exemplary embodiment should not be viewed as limiting the invention as defined by the claims. In some embodiments a request for action comprises a task and/or a ToDo. In some embodiments a request for action comprises an inquiry, a request for information, a task, and/or a ToDo. In some embodiments, a task is a ToDo.

In some embodiments, users listed in the To section of a task electronic communication will be sent a task. In some embodiments, a task is a ToDo. In some embodiments, the task is evenly distributed between the users listed in the To field of the electronic communication. For example, listing two people in the To field of the electronic communication assigns 50% percent of the task to each recipient. In some embodiments, when the first recipient completes his portion of the task and the second assignee is not finished, the task is partially completed, for example 50% completed. However, the same task from the viewpoint of the recipient who has completed the task is 100% complete. In various embodiments, each recipient is assigned a different percent of the task to be completed. In some embodiments, recipients listed in the Cc or Bcc field will receive the electronic communication as an FYI. In some embodiments a request for action comprises a task and/or a ToDo. In some embodiments a request for action comprises an inquiry, a request for information, a task, and/or a ToDo.

In some embodiments, a sender composes an electronic communication 501, for example an email. In some embodiments, text is included in the electronic communication, the text comprising a task. In some embodiments, one or more recipients, one or more Cc'd persons, and/or one or more Bcc'd persons are included in the electronic communication. In some embodiments, each of the one or more recipients is assigned at least a portion of the task. In some embodiments, the sender assigns the task to himself (i.e., a Self ToDo). In some embodiments the sender of the electronic communication inputs a subject of the electronic communication. In some embodiments, the due date is the date by which the recipient of the electronic communication should complete the task. In some embodiments, the sender assigns the task a start date. In some embodiments, when the sender Cc's and/or Bcc's additional recipients, the electronic communication is tagged as FYI for the additional recipients. In some embodiments, at 502, the sender via an interface element 209 tags and sends the inquiry communication. In some embodiments a request for action comprises a task and/or a ToDo. In some embodiments a request for action comprises an inquiry, a request for information, a task, and/or a ToDo.

In some embodiments, the sender assigns the task and/or the electronic communication an attribute, comprising, for example a project title that includes a description of the task, and/or a reason for executing the task. In some embodiments, the sender assigns a status to the task, the status comprising, for example, a progress of the task, whether the task has been started, in progress, completed, a percentage completed, and/or status of a related task and/or inquiry to which the current task is dependent. In some embodiments a request for action comprises a task and/or a ToDo. In some embodiments a request for action comprises an inquiry, a request for information, a task, and/or a ToDo.

In some aspects, a task electronic communication is sent to a project manager client system prior to or in parallel with the delivery of the task electronic communication to the recipient. In some embodiments, the project manager approves, rejects, or defers the task electronic communication. The project manager, in some embodiments, annotates the task electronic communication to indicate a reason for approval, rejection, or deferral the task. When the project manager rejects the task, a rejection electronic communication is sent to the sender and/or each of the original recipients. When the project manager approves the task, an acceptance electronic communication is sent to the sender and/or each of the original recipients comprising the recipient to whom the task is intended. In some embodiments, the project manager requests the generation of an association between the received task in the task electronic communication and another task. When the project manager defers the task, an electronic communication is sent to the sender and/or each of the electronic communication recipients of the original electronic communication. In some embodiments a request for action comprises a task and/or a ToDo. In some embodiments a request for action comprises an inquiry, a request for information, a task, and/or a ToDo.

In some embodiments, the recipient to whom the task is assigned accepts the task 503. In some embodiments, the recipient generates a response to the task electronic communication. In various embodiments, the response comprises an electronic communication, an email, an instant message, a text message, an internal system communication and the like. In some embodiments, the recipient agrees to complete task terms assigned to him and sends an additional electronic communication to the sender and/or the other recipients indicating acceptance of all term in the task. In some embodiments, the additional electronic communication comprises an email, an instant message, a text, an internal system communication and the like. In some embodiments, the recipient, changes a time for completing the task and indicates the newly proposed time of completion in a response electronic communication. In some embodiments, the recipient requests generation of an association between the received task in the task electronic communication and another task. In some embodiments a request for action comprises a task and/or a ToDo. In some embodiments a request for action comprises an inquiry, a request for information, a task, and/or a ToDo.

In some embodiments, the recipient rejects the task 504. Rejection of the task, in some embodiments, comprises annotating the task electronic communication or tagging the task electronic communication. In some embodiments, a response is sent from the recipient that indicates the rejection, the response comprising an electronic communication, an email message, an instant message, a text message, an internal system communication or the like. In some embodiments, deleting the task electronic communication rejects the task. In various embodiments, the metadata of the electronic communication is updated when the electronic communication is deleted to reflect that the task was rejected. In some embodiments, deleting the task sends an electronic communication to the original recipients of the task to indicate the task was rejected. In some embodiments, the recipient requests generation of another task electronic communication in which all, a portion, or one or more portions of the task are re-assigned to one or more other recipients via the task electronic communication. In some embodiments a request for action comprises a task and/or a ToDo. In some embodiments a request for action comprises an inquiry, a request for information, a task, and/or a ToDo.

In some embodiments, a communication life cycle comprises a plurality of electronic communications, for example a plurality of emails, text messages, voice messages, and/or a combination thereof. In some embodiments, in FIG. 3, FIG. 4, and FIG. 5 the Assignee is a recipient.

In some embodiments a request for action comprises an inquiry, a request for information, an update, a ToDo, and/or a Self ToDo. In some embodiments, an electronic communication comprises an email, a text message, an instant message and/or a voice message.

In some aspects, the compose interface is further configured to allow the user to select a watcher, wherein the watcher will receive the electronic communication, all replies to the electronic communications, and updates to the electronic communication. In some embodiments, all replies to the electronic communications, and updates to the electronic communication are sent as an FYI communication to the watcher. In some embodiments, the compose interface is configured to permit selection of the watcher after the electronic communication is sent.

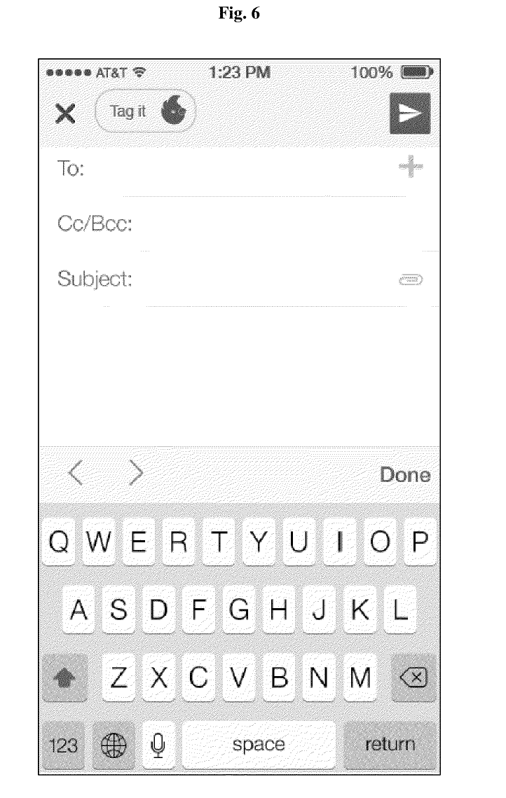

In some aspects, the systems, methods, media, and platforms described herein comprise a software module to provide an interface to type. As depicted in a non-limiting example in FIG. 6, in some embodiments, an interface to type the names of one or more recipients, one or more recipients CC'd and/or BCC'd, the subject and/or the message of the electronic communication is provided. In some embodiments, the interface to type the names of one or more recipients, one or more recipients CC'd and/or BCC'd, the subject and/or the message of the electronic communication comprises a keyboard. In some embodiments, the keyboard is part of a native software module of the device on which the computer-implemented electronic communication system for improving electronic communication based workflow management is run. In some embodiments, an interface element, for example a tag it interface element is used to display the tags depicted at 209. In some embodiments, additional tags, for example user-defined tags are displayed.

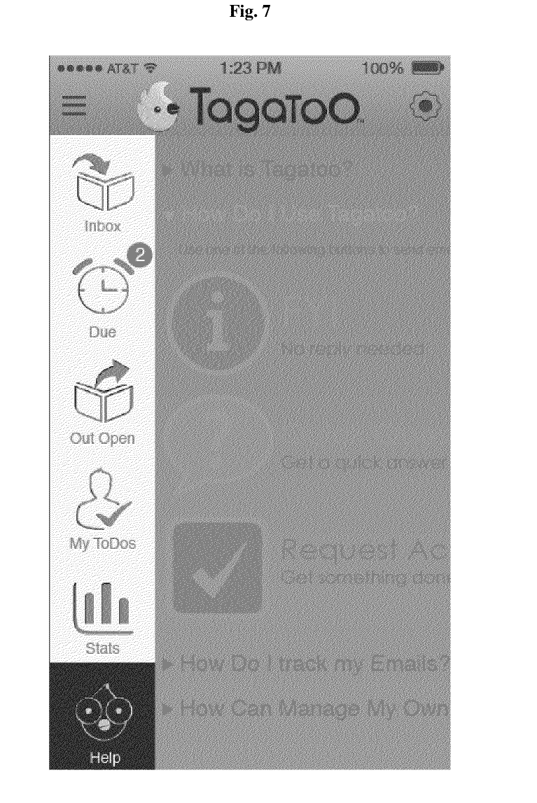

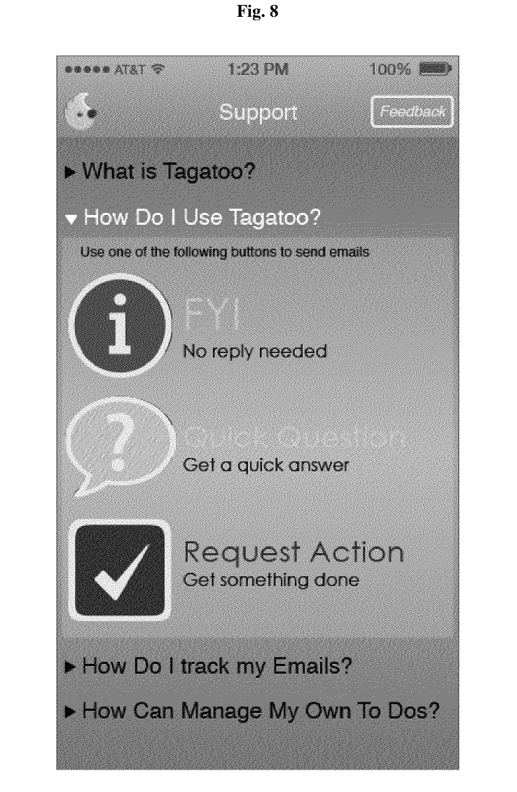

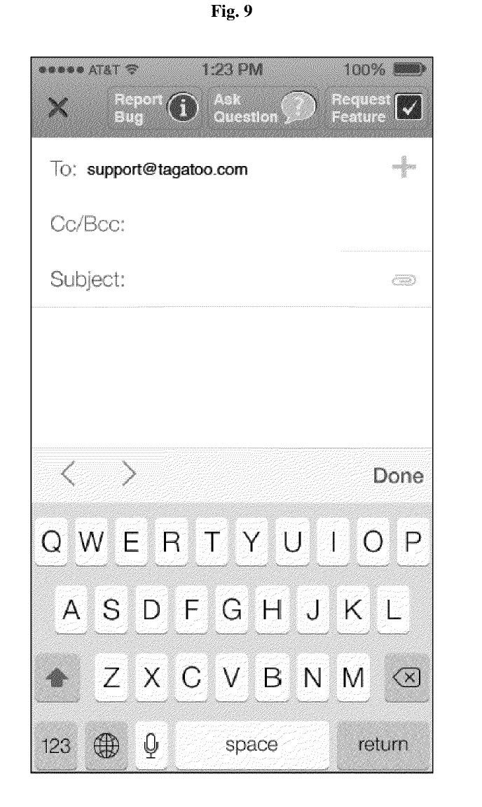

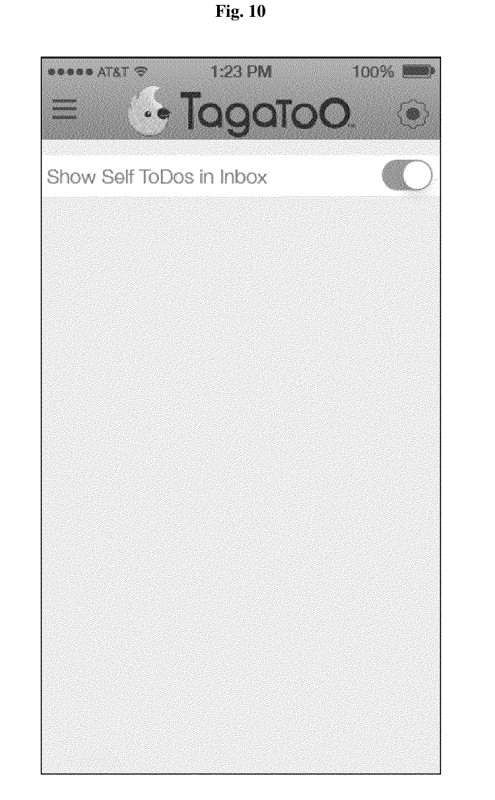

In some aspects, the systems, methods, media, and platforms described herein comprise a software module to provide a support interface. As depicted in a non-limiting example in FIG. 7, in some embodiments the platforms, methods, systems and media described herein comprise a software module configure to provide a Help interface element. A user who selects the Help interface element displays the Support interface as depicted in a non-limiting example in FIG. 8. In some embodiments, the Support interface provides an interface element to communicate with the provider of the systems, methods, media, and platforms described herein, for example, as depicted in a non-limiting example in FIG. 9, to report a bug, to ask a question, and to request a feature. In some embodiments, interface elements are provided to tag and send the electronic communication as a report bug electronic communication, tag and send the electronic communication as a ask question electronic communication, and tag and send the electronic communication as a request feature electronic communication. In some embodiments, a report bug electronic communication is an FYI, an ask question electronic communication is an inquiry, and a request feature electronic communication is a task electronic communication. In some embodiments, as depicted in a non-limiting example in FIG. 10, an interface to turn on and off Self ToDos is provided. In some embodiments, the interface element to turn on and off displaying Self ToDos in the user's Inbox is a slideable interface element, a dropdown menu, and/or a button. In some embodiments a request for action comprises a task and/or a ToDo. In some embodiments a request for action comprises an inquiry, a request for information, a task, and/or a ToDo.

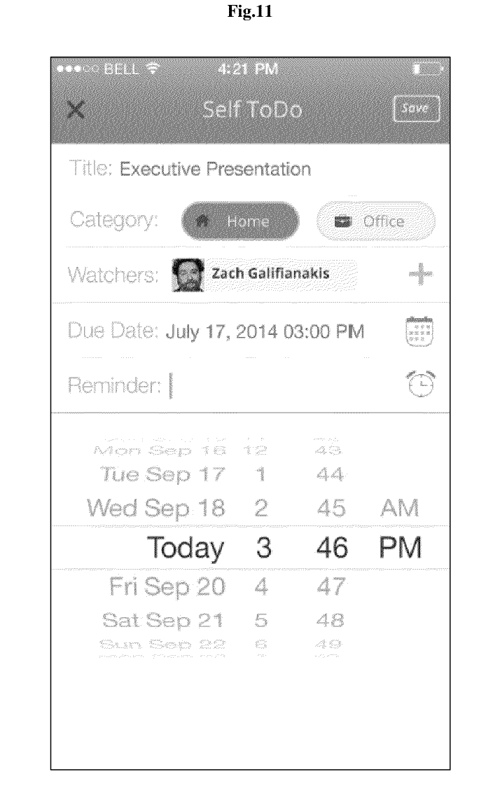

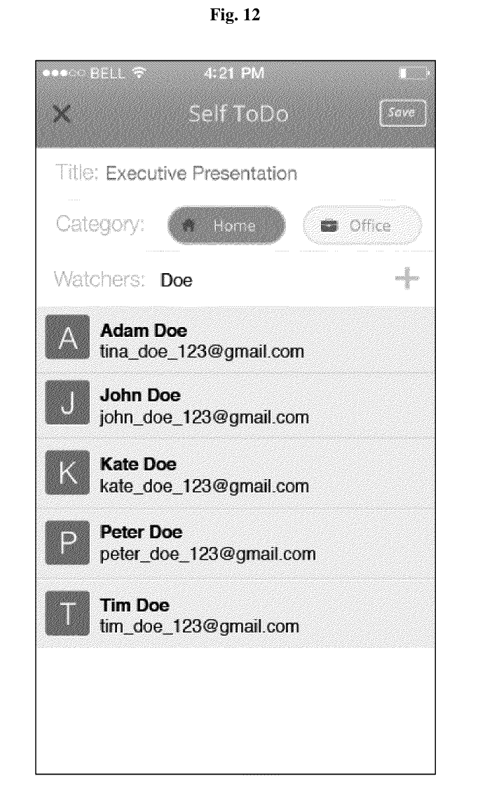

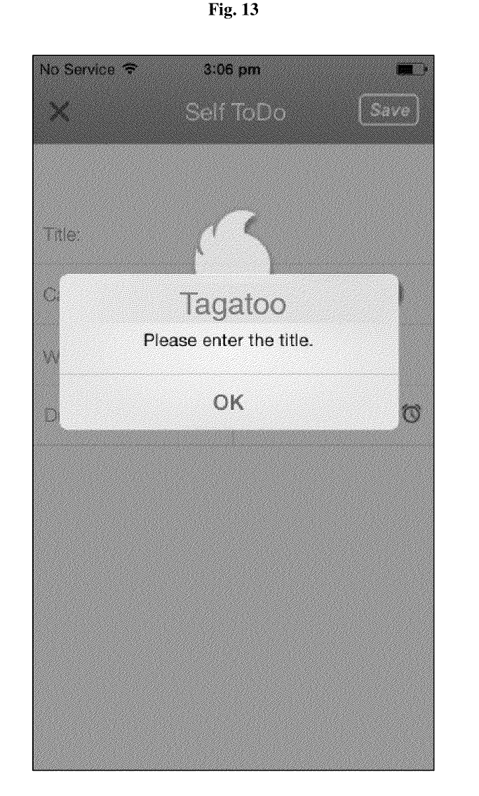

As depicted in a non-limiting example in FIG. 11 and FIG. 12, in some embodiments the platforms, methods, systems and media described herein comprise a software module configure to provide a Self ToDo interface to generate a Self ToDo electronic communication. In some embodiments the Self ToDo electronic communication is a task. In some embodiments the software module or another software module is configured to provide an interface element to title the Self ToDo, an interface element to select a category of the Self ToDo, an interface element to add a watcher to the Self ToDo, an interface element to set a Due Date of the Self ToDo, and/or an interface element to set a reminder time of the Self ToDo. In some embodiments, selection of a Home category indicates the Self ToDo is not work-related, whereas selection of an Office category indicates the Self ToDo is work-related. In some embodiments, a watcher who is added to the Self ToDo receives the communication and all updates to the communication as an FYI. In some embodiments, the watcher is CC'd on the Self ToDo electronic communication and all updates to the electronic communication. In some embodiments, a calendar interface is provided to select a due date, a day and time interface is provided to select a reminder date and time. As depicted in a non-limiting example in FIG. 13, in some embodiments the platforms, methods, systems and media described herein comprise a software module configured to provide an overlay to enter a Self ToDo title.

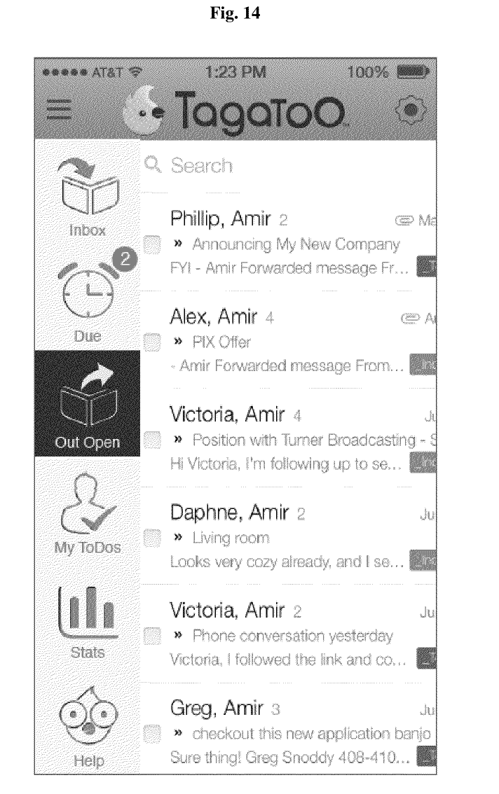

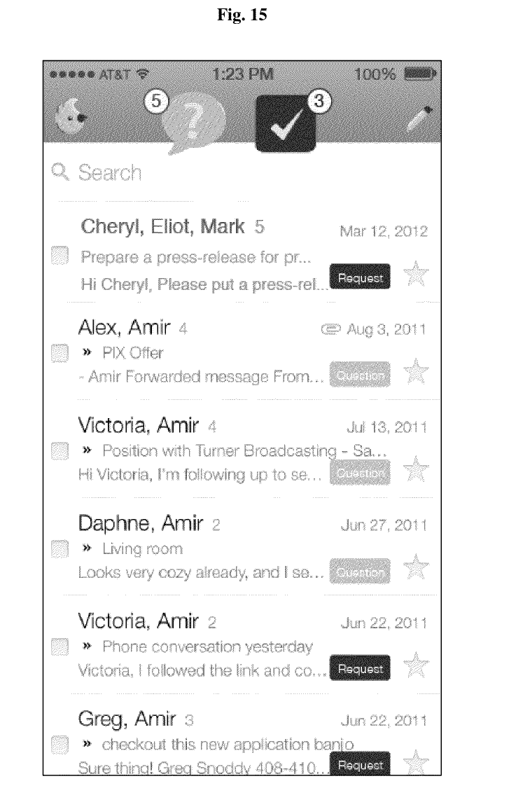

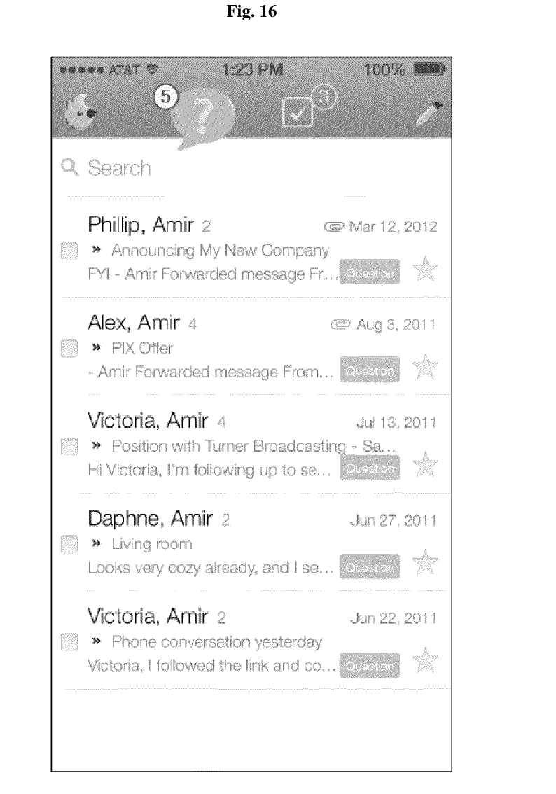

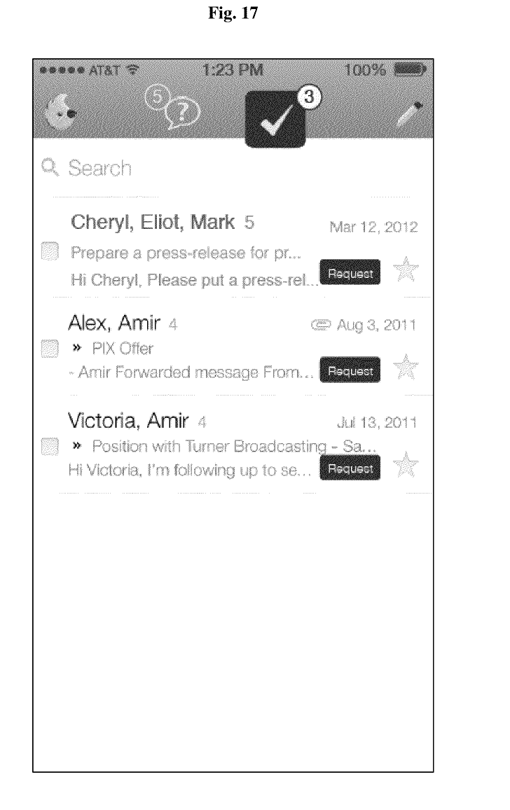

In some aspects, the systems, methods, media, and platforms described herein comprise a software module to provide an Out Open interface. As depicted in a non-limiting example in FIG. 14, in some embodiments the platforms, methods, systems and media described herein comprise a software module configure to provide an Out Open interface element. In some embodiments, the Out Open interface is configured to display Out Open electronic communications in an Out Open interface, the Out Open electronic communications comprising one or more of requests for action, tasks, and inquiries. In some embodiments, a task is a ToDo. In some embodiments a request for action comprises a task and/or a ToDo. In some embodiments a request for action comprises an inquiry, a request for information, a task, and/or a ToDo. As depicted in a non-limiting example in FIG. 15, in some embodiments the platforms, methods, systems and media described herein comprise a software module configure to provide an interface to display Out Open electronic communications comprising a request for action tag, an inquiry tag, and/or a task tag. In some embodiments, a task tag is a ToDo tag. In some embodiments a request for action comprises a task and/or a ToDo. In some embodiments a request for action comprises an inquiry, a request for information, a task, and/or a ToDo. In some embodiments a number of Out Open electronic communications are displayed. As depicted in a non-limiting example in FIG. 16, the interface comprises an interactive interface element displays Out Open inquiry electronic communications. In some embodiments, a number of Out Open inquiry electronic communications is displayed next to the icon. As depicted in a non-limiting example in FIG. 17, the interface comprises an interactive interface element displays Out Open request for action and/or task electronic communications. In some embodiments, a number of Out Open request for action and/or task electronic communications is displayed next to the icon.

### Receiving Module

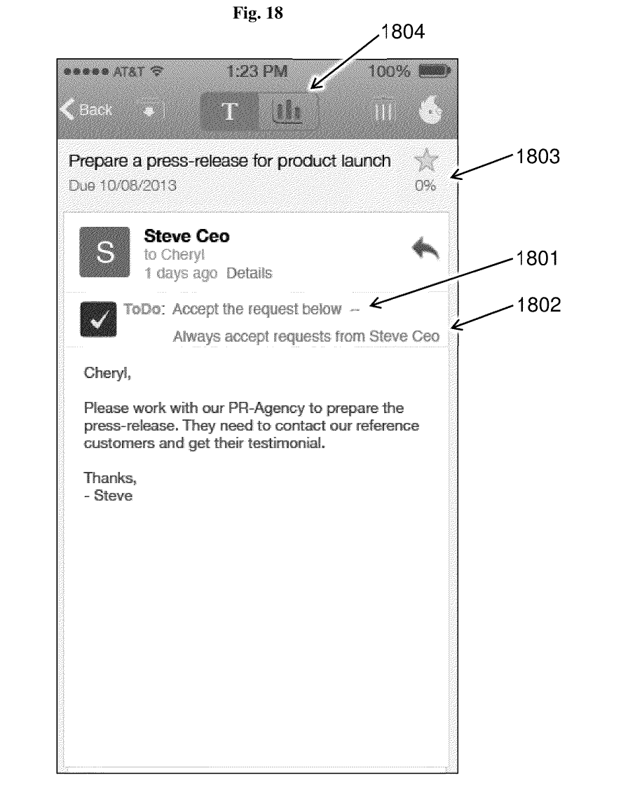

In some aspects, the systems, methods, platforms and media described herein comprise a software receiving module configured to receive the electronic communication, identify the electronic communication based on the electronic communication metadata, and provide a receipt interface comprising a first interface element corresponding to the first tag and a second interface element corresponding to the second tag, wherein selection of the first interface element displays only a request for action electronic communication and selection of the second interface element displays only an FYI electronic communication. A non-limiting example of the receipt interface is depicted in FIG. 18. In some embodiments, the receipt interface comprises an interactive interface element to accept a request for action 1801, and/or to always accept requests for action from a sender 1802. In certain embodiments, a request for action comprises a task, and/or an inquiry. In some embodiments the receipt interface comprises an interactive interface element to accept a task and/or an inquiry. In some embodiments, a task is a ToDo. In some embodiments the receipt interface comprises a visual indication of a percent completion 1803 of the request for action. In some embodiments a Due Date is displayed on the receipt interface. In various embodiments, the receipt interface comprises an interactive interface element 1804 to allow a user to display a graphical representation of the request for action communication life cycle.

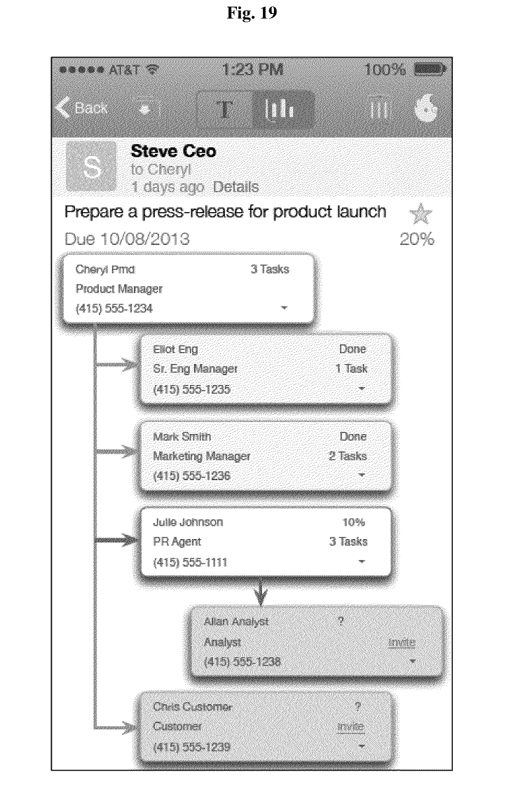

As depicted in FIG. 19 in some embodiments the platforms, methods, systems and media described herein comprise a software module configure to provide a chart interface. In various embodiments, the chart interface is configured to display a graphical representation of the communication life cycle. In some embodiments the chart interface is configured to display a delegation chart, which visually depicts dependencies between one or more requests for action, one or more tasks, one or more inquiries, and/or a combination thereof. In some embodiments, the chart interface displays a relationship between one electronic communication and all related forwarded, delegated, complete, and/or deleted electronic communications. In some embodiments, the chart interface comprises an interface element to depict a percent complete of the request for action and/or task. In some embodiments, the chart interface is configured to display a report based on one or more of the classification data and the metadata. In various embodiments, a graphical representation comprises a sent request for action electronic communication, delegation of the request for action, and percent complete of the request for action.

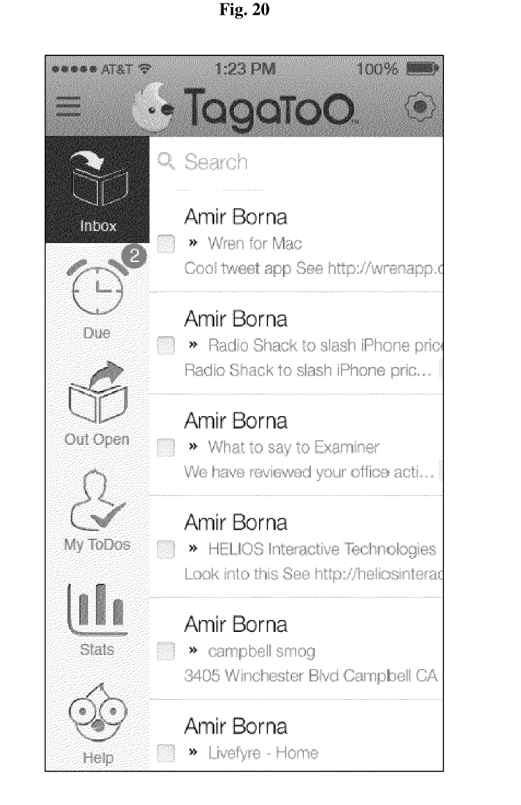

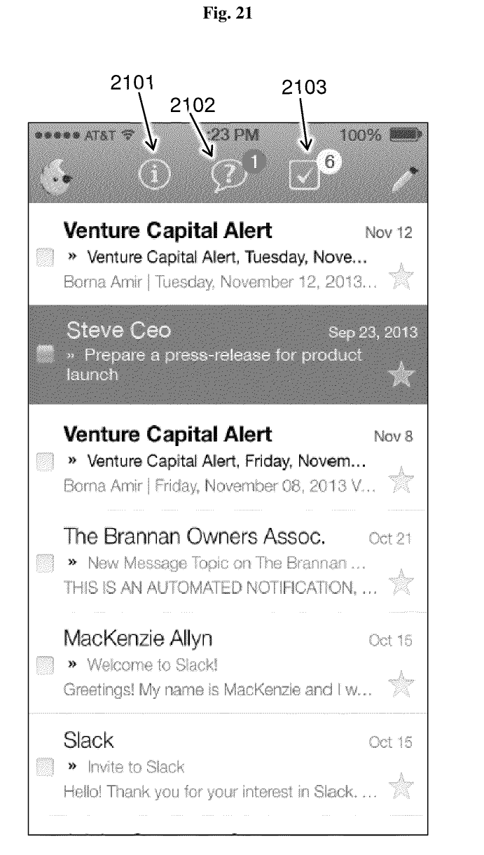

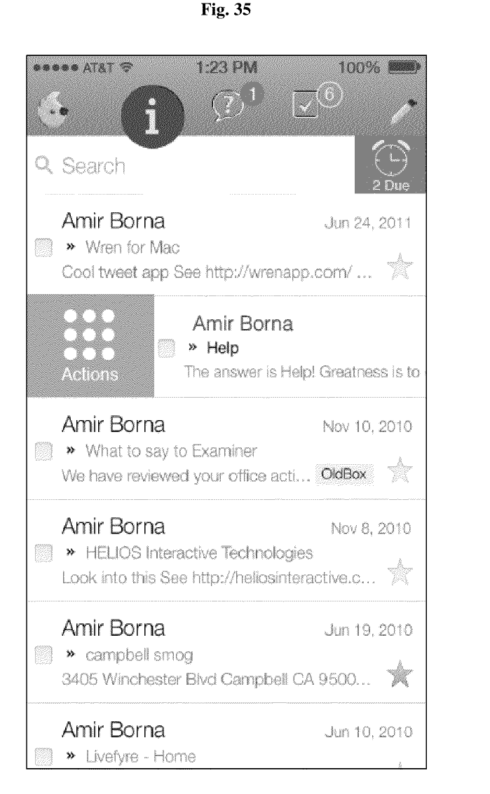

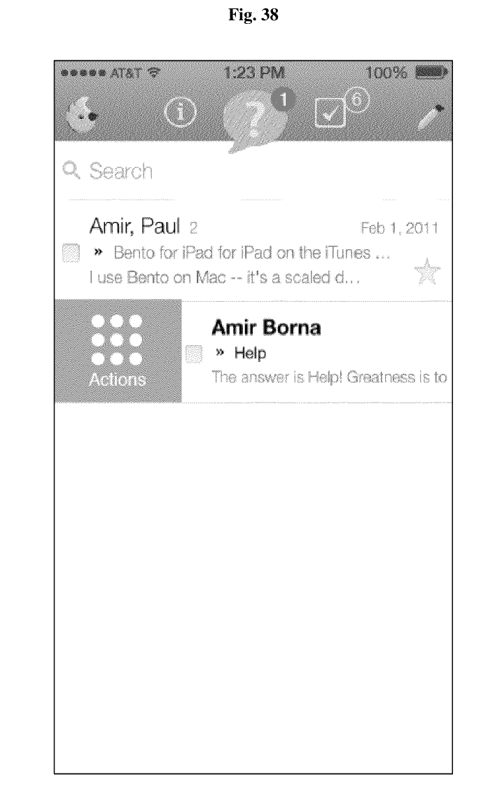

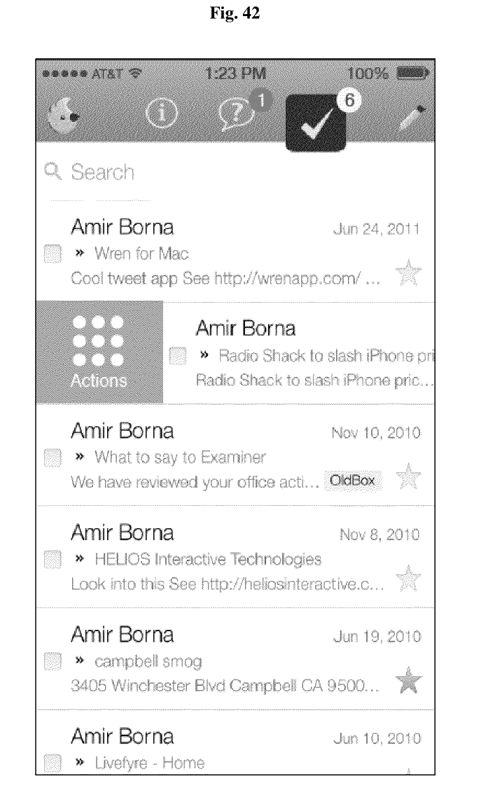

In some aspects, the systems, methods, media, and platforms described herein comprise a software module to display a receipt interface, for example an inbox. As depicted in a non-limiting example in FIG. 20, in some embodiments of the platforms, methods, systems and media described herein the interface comprises a interface element to display the receipt interface, for example an inbox. As depicted in FIG. 21, in some embodiments of the platforms, methods, systems and media described herein the receipt interface, for example the inbox, comprises one or more of an interactive interface element to display electronic communications tagged as an FYI 2101, an interactive interface element to display electronic communications tagged as an inquiry 2102, an interactive interface element to display electronic communications tagged as a task 2103, and an interactive interface element to display electronic communications tagged as a request for action. In some embodiments, a number of unread electronic communications is displayed next to each interactive interface element. In some embodiments, a number of incomplete inquiries is displayed next to the interactive interface element to display electronic communications tagged as an inquiry. In some embodiments, a number of incomplete tasks is displayed next to the interactive interface element to display electronic communications tagged as a task. In some embodiments, a number of incomplete requests for action is displayed next to the interactive interface element to display electronic communications tagged as a request for action. In some embodiments, selecting the interactive interface element to display electronic communications tagged as an FYI displays only electronic communications tagged as an FYI (see, e.g., FIG. 35). In some embodiments, selecting the interactive interface element to display electronic communications tagged as an inquiry displays only electronic communications tagged as an inquiry (see, e.g., FIG. 38). In some embodiments, selecting the interactive interface element to display electronic communications tagged as a task displays only electronic communications tagged as a task (see, e.g., FIG. 42). In some embodiments, selecting the interactive interface element to display electronic communications tagged as a request for action displays only electronic communications tagged as a request for action. In some embodiments a request for action comprises a task and/or a ToDo. In some embodiments a request for action comprises an inquiry, a request for information, a task, and/or a ToDo.

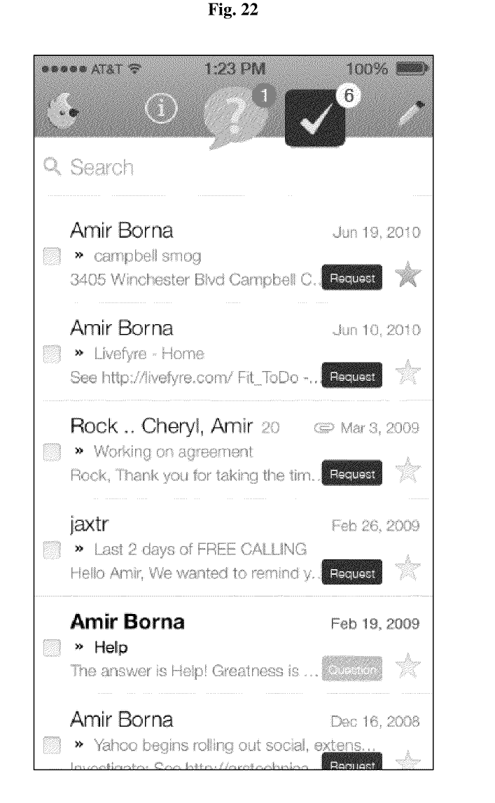

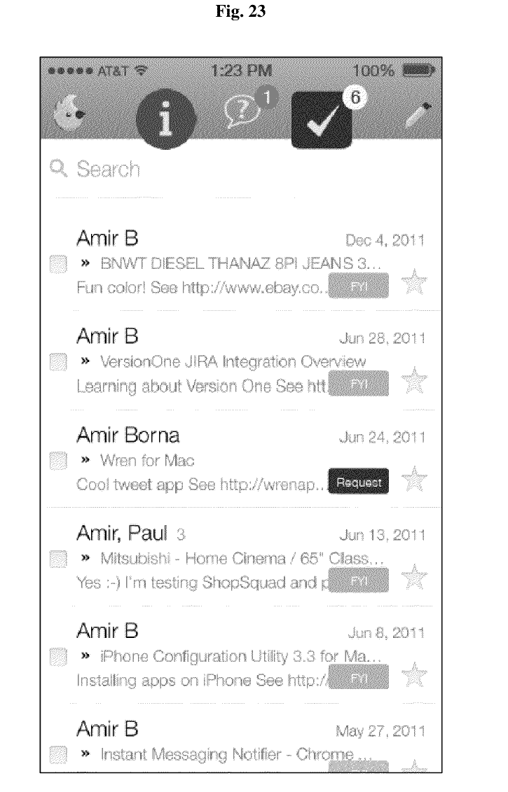

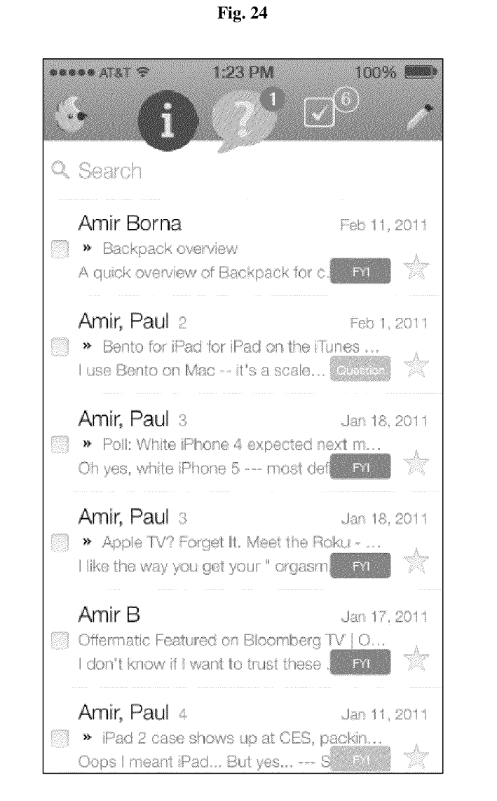

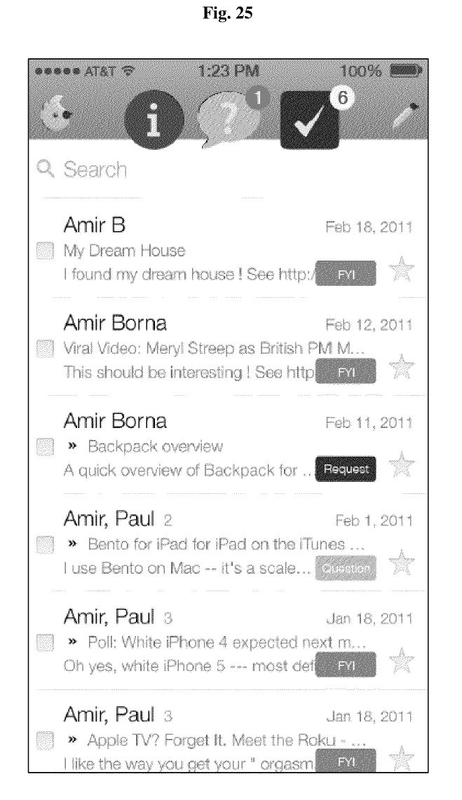

As depicted in FIGS. 22-25, in some embodiments, more than one interactive interface element is selected displaying electronic communications comprising different tag types. In various embodiments, as depicted in FIG. 22, selecting the interactive interface element to display electronic communications tagged as an inquiry and the interactive interface element to display electronic communications tagged as a task, displays electronic communications tagged as an inquiry and electronic communications tagged as a task. In various embodiments, as depicted in FIG. 23, selecting the interactive interface element to display electronic communications tagged as an FYI and the interactive interface element to display electronic communications tagged as a task, displays electronic communications tagged as an FYI and electronic communications tagged as a task. In various embodiments, as depicted in FIG. 24, selecting the interactive interface element to display electronic communications tagged as an FYI and the interactive interface element to display electronic communications tagged as an inquiry, displays electronic communications tagged as an FYI and electronic communications tagged as an inquiry. In various embodiments, as depicted in FIG. 25, selecting the interactive interface element to display electronic communications tagged as an FYI, the interactive interface element to display electronic communications tagged as an inquiry, and the interactive interface element to display electronic communications tagged as a task displays electronic communications tagged as an FYI, electronic communications tagged as an inquiry, and electronic communications tagged as a task. In various embodiments, selecting the interactive interface element to display electronic communications tagged as an inquiry and interactive interface element to display electronic communications tagged as a request for action, displays electronic communications tagged as an inquiry and electronic communications tagged as a request for action. In various embodiments, selecting the interactive interface element to display electronic communications tagged as an FYI and interactive interface element to display electronic communications tagged as a request for action, displays electronic communications tagged as an FYI and electronic communications tagged as a request for action. In some embodiments, a request for action is an inquiry and/or a task.

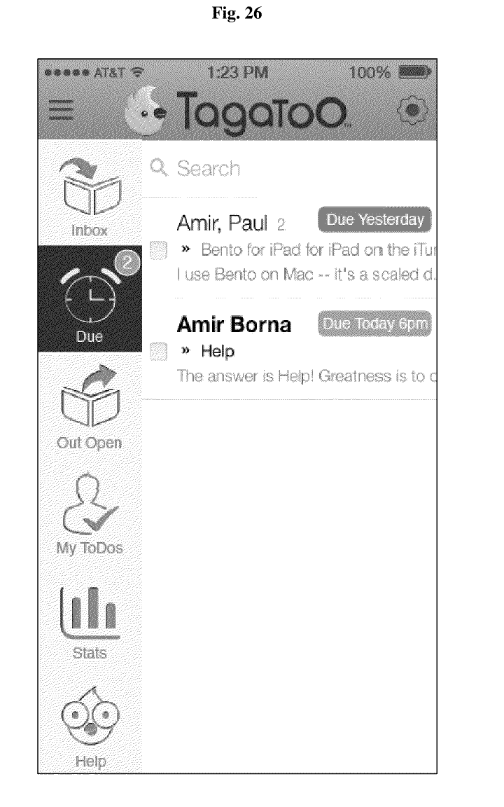

In some aspects, the systems, methods, platforms and media described herein comprise, the client application comprises a software displaying module configured to provide a due interface to display one or more due items. As depicted in a non-limiting example in FIG. 26, in some embodiments, the platforms, methods, systems and media described herein comprise an interface element to display the due interface. In some embodiments a number of incomplete electronic communications comprising a request for action tag, electronic communications comprising a task tag, and/or electronic communications comprising an inquiry tag are displayed next to the interface element to display the due interface.

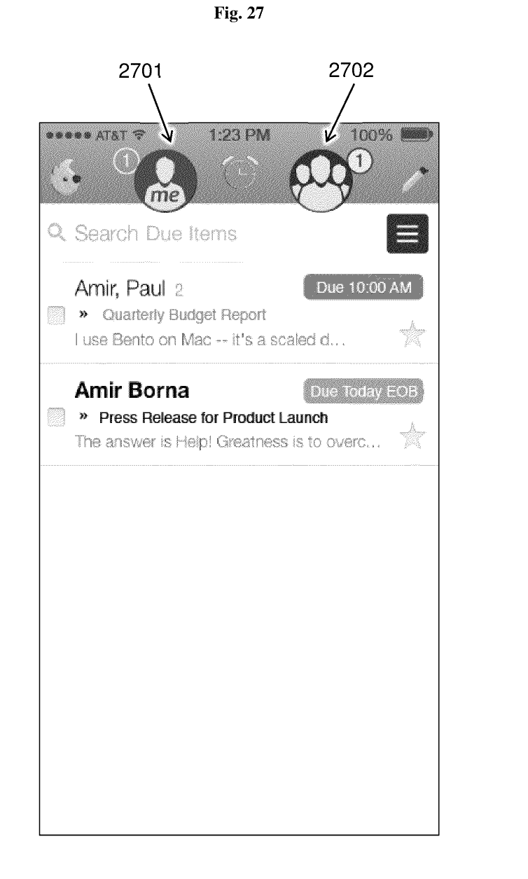

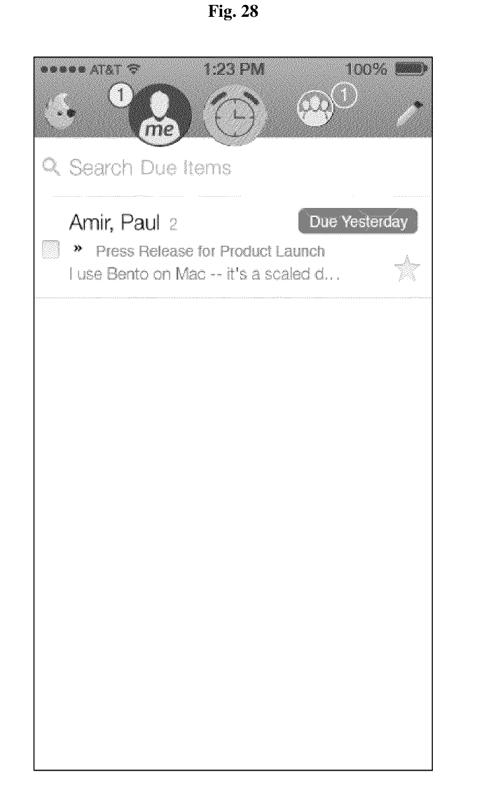

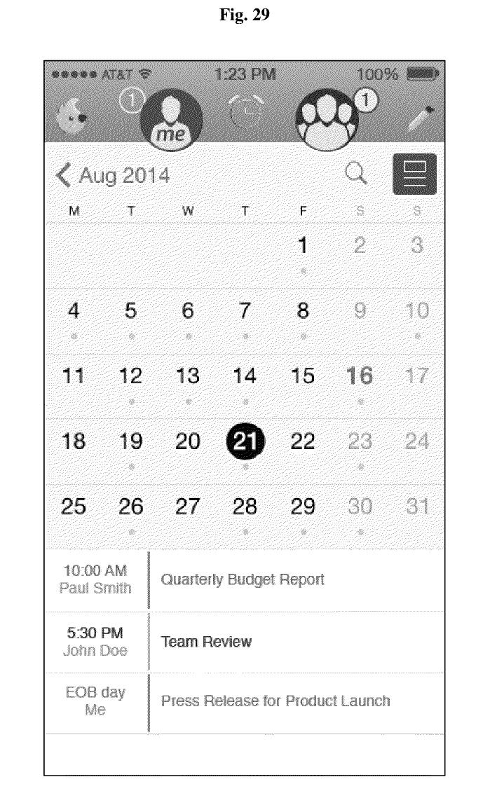

In some aspects, the systems, methods, media, and platforms described herein comprise a software displaying module configured to provide an interface to display one or more due items (i.e., a due interface). In some embodiments, the one or more due items are displayed with corresponding due dates. A non-limiting example of the due interface is depicted in FIG. 27. In some embodiments the due interface comprises an interactive interface element 2701 configured to display only Self ToDo electronic communications. As depicted in a non-limiting example in FIG. 28, when the interactive interface element configured to display only Self ToDo electronic communications is selected, electronic communications that are not Self ToDo are not displayed. In some embodiments, a number of unread and/or incomplete Self ToDo electronic communications is displayed next to the interactive interface element configured to display only Self ToDo electronic communications. In some embodiments the due interface comprises an interactive interface element 2702 configured to display only received electronic communications comprising one or more of an inquiry tag, a task tag, and a request for action tag. In some embodiments, a number of unread and/or incomplete inquiry electronic communications, task electronic communications, and/or requests for action electronic communications is displayed next to the interactive interface element configured to display only received electronic communications comprising one or more of an inquiry tag, a task tag, and a request for action tag. As depicted in FIG. 29, in various embodiments, the due interface comprises a calendar view comprising a calendar, the calendar view configured to display due items on the calendar. In some embodiments, the due interface is configured to display due items on a calendar, a grid, or a list.

In some embodiments, the one or more due items are displayed with corresponding due dates. In some embodiments, corresponding due dates are color coded. In various embodiments, a color coded indicator is provided with each of the one or more due items. The color coded due dates and/or the color coded indicator are colored such that due items with due dates closer in time to the date on which the due interface is accessed are colored differently than due items with due dates farther in time to the date on which the due interface is accessed. For example due items with a due date of the following day may have red due dates and/or red indicators, whereas due items with a due date in one week have green due dates and/or green indicators. In some embodiments, the colors and time periods to which the colors indicate are adjustable by the user. In various embodiments, overdue items are displayed.

In some aspects, software displaying module configured to provide an interface to display one or more due items (i.e., a due interface), is further configured to the display the electronic communication comprising a due-date within a user-defined time period relative to the date in which the system promotes the electronic communication to the due interface, and wherein a plurality of electronic communications are displayed according to their completion deadline. In some embodiments, the user-defined time period is in the future or the past relative to the date in which the system promotes the electronic communication to the due interface. In various embodiments, a sent and a received electronic communication are displayed.

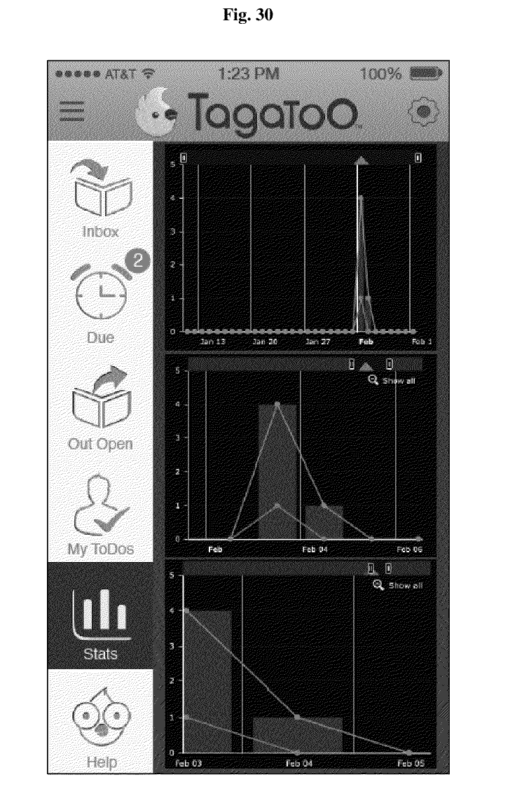

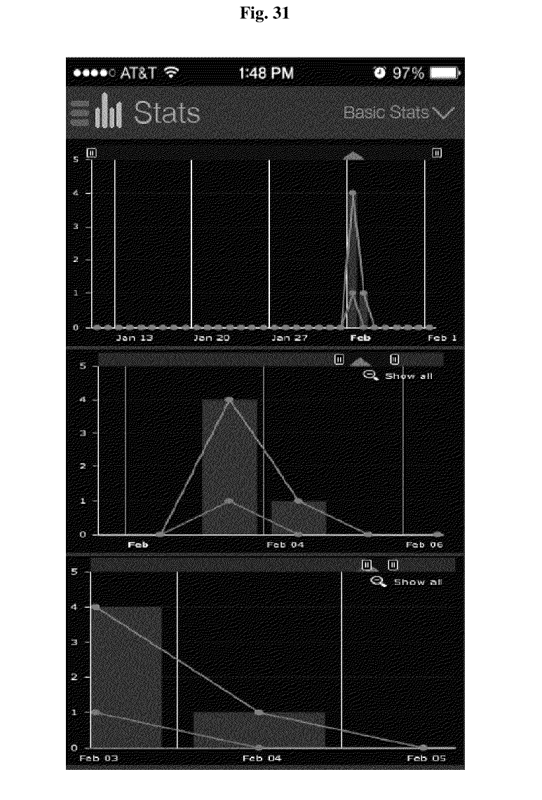

In some aspects, the platforms, methods, systems and media described herein comprise a software module configured to provide a stats interface. As depicted in a non-limiting example in FIG. 30, in some embodiments of the platforms, methods, systems and media described herein the interface comprises an interface element to display the stats interface. A non-limiting example of the stats interface is depicted in FIG. 31. In some embodiments, the stats interface depicts the number of tasks, inquiries, and/or requests for action due within a time period.

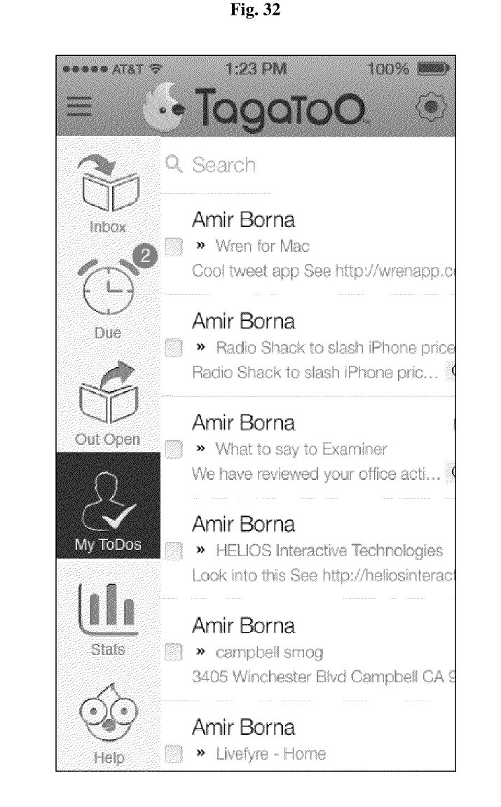

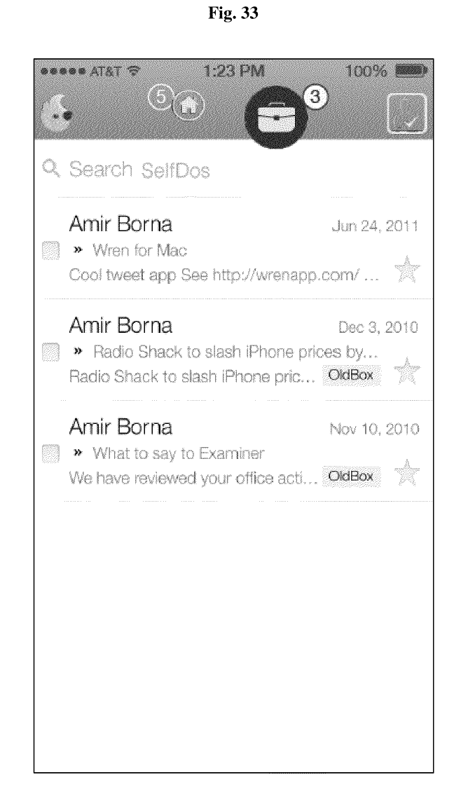

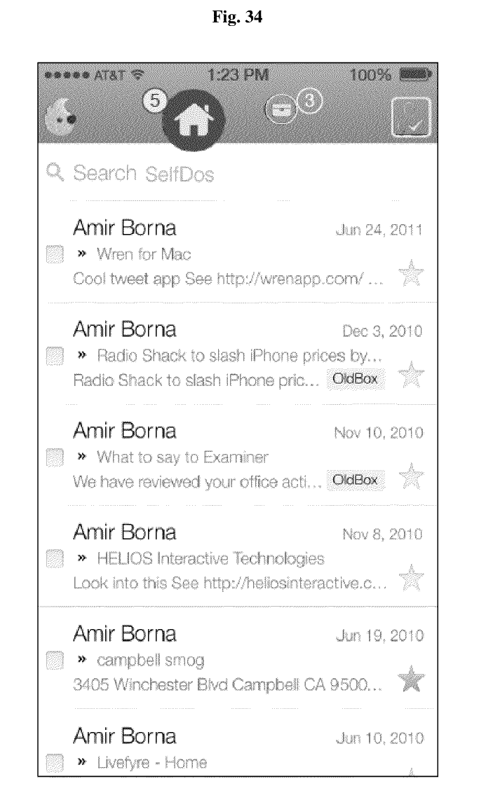

In some aspects, the platforms, methods, systems and media described herein comprise a software module configured to provide the My ToDo interface. As depicted in a non-limiting example in FIG. 32, in some embodiments of the platforms, methods, systems and media described herein the interface comprises a interface element to display a My ToDos interface. In various embodiments, as depicted in a non-limiting example in FIG. 33, the My ToDos interface comprises an interactive interface element configured to display Self ToDos designated as work-related. In some embodiments, a number of incomplete work-related Self ToDos are displayed next to the interactive interface element configured to display Self ToDos designated as work-related. In various embodiments, as depicted in a non-limiting example in FIG. 34, the My ToDos interface comprises an interactive interface element configured to display Self ToDos designated as home-related. In some embodiments, a number of incomplete work-related Self ToDos are displayed next to the interactive interface element configured to display Self ToDos designated as home-related.

### Responding Module

In some aspects, the systems, methods, platforms and media described herein comprise a software responding module configured to provide an interface to respond to the electronic communication, wherein a response to the request for action electronic communication comprises one or more of accepting the request for action, declining the request for action, a response to the request for action, a delegation of the request for action, and a percent complete, and wherein a response to the FYI electronic communication requires generation of another communication life cycle.

In various embodiments, a request for action, an inquiry and/or a task is delegated to one or more recipients. In various embodiments, the electronic communication will be sent with tags of the original electronic communication. For example, in case of an inquiry electronic communication, when a message is forwarded to more than one person each recipient receives an inquiry and anyone answering the inquiry will cause the inquiry and/or communication life cycle to be complete. As another example, in the case of a task, when the electronic communication is forwarded to more than one person, the task is evenly divided between the recipients and each has to finish their assigned percentage to be complete the task and/or the communication life cycle. In some embodiments, when forwarding a task electronic communication, the percentages assigned to more than one recipient are not equal but are able to be modified by the sender.

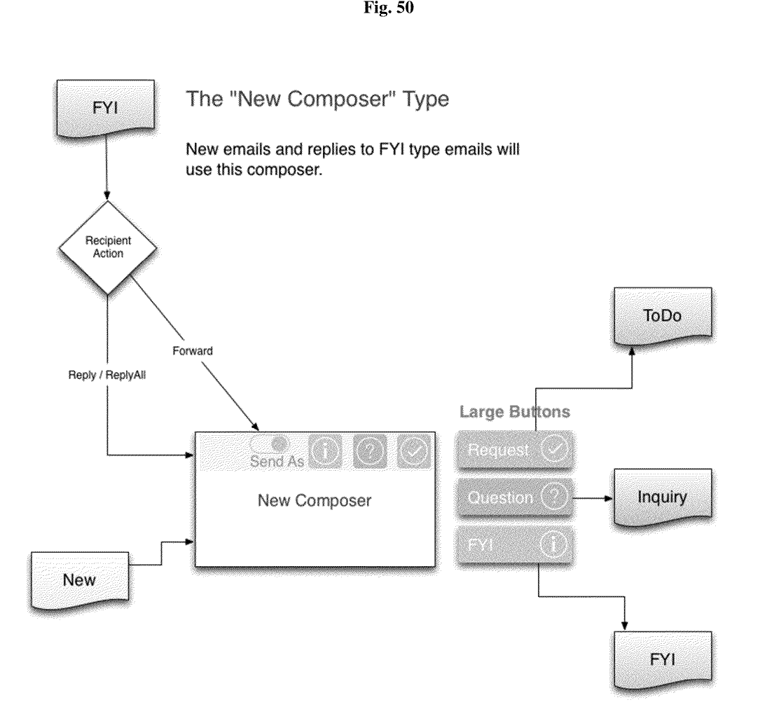

As a non-limiting example, FIG. 50 depicts a New Composer. In some embodiments, the new composer is used for composing a new electronic communication. In various embodiments, a new electronic communication is composed to start a new communication life cycle or respond to a received electronic communication, for example an FYI electronic communication. In some embodiments, the compose interface uses the New Composer.

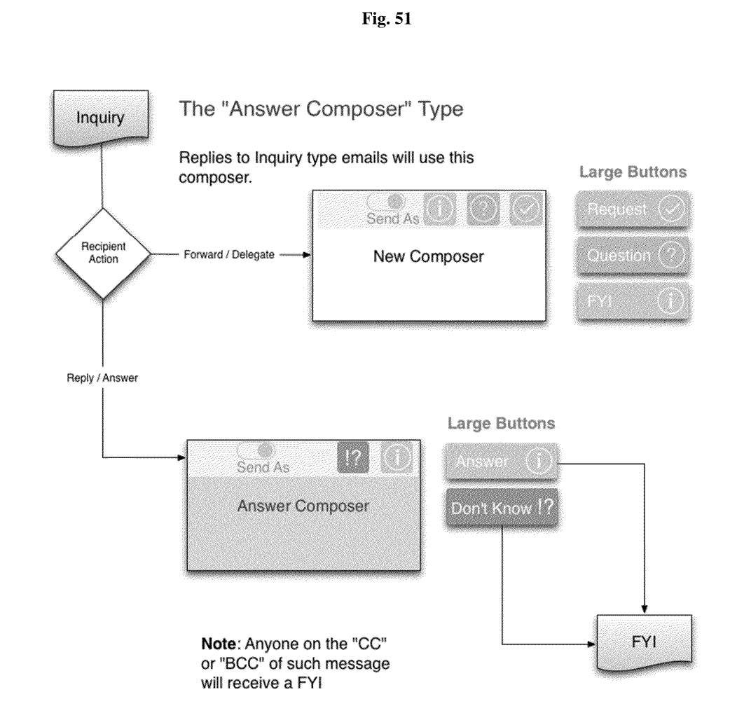

As a non-limiting example, FIG. 51 depicts an Answer Composer. In some embodiments, the Answer Composer is used to reply to an inquiry electronic communication.

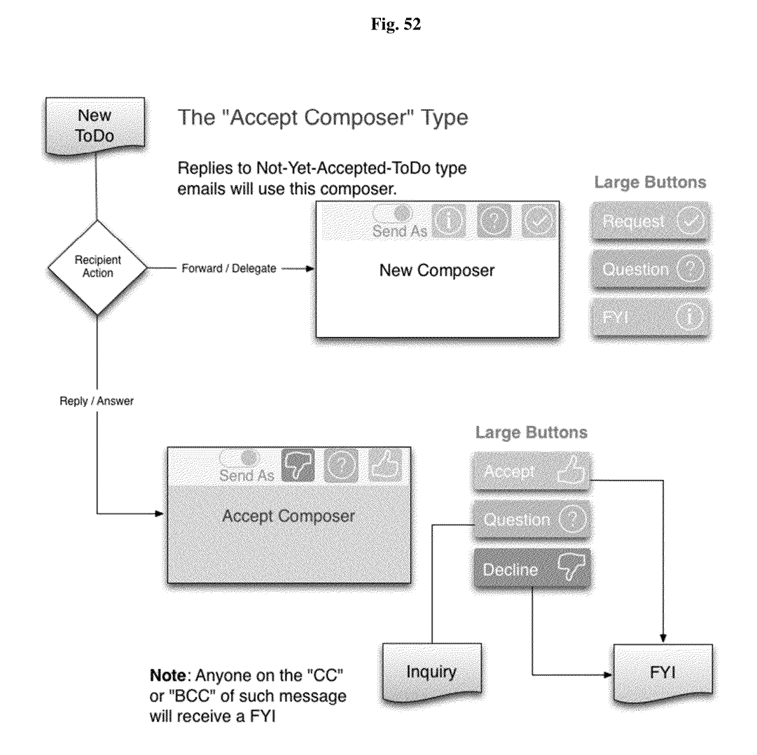

As a non-limiting example, FIG. 52 depicts an Accept Composer. In some embodiments, the Accept Composer is used to accept a request for action. In some embodiments, a request for action is a task. In various embodiments, a task is a ToDo.

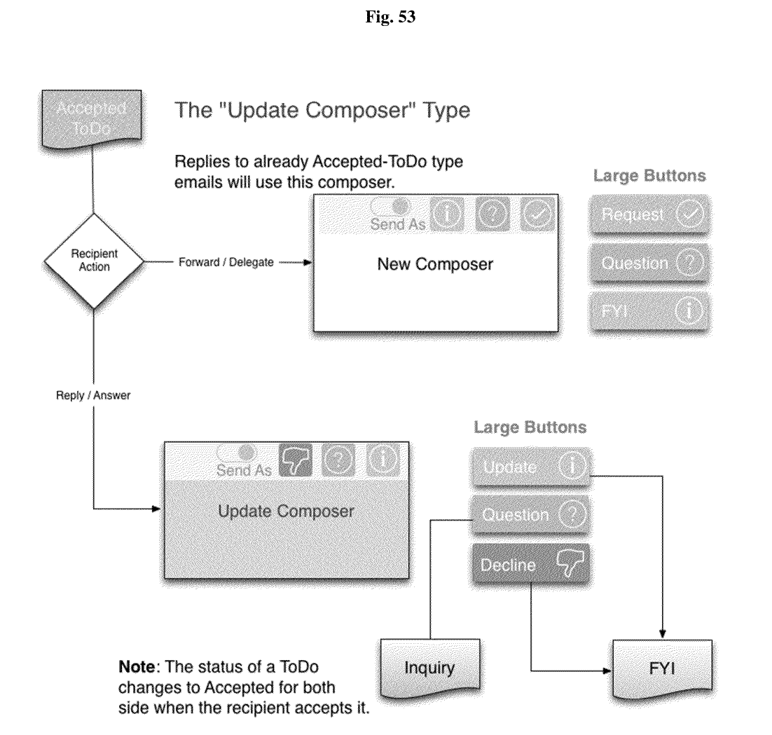

As a non-limiting example, FIG. 53 depicts an Update Composer. In some embodiments, the Update Composer is used to respond or update an accepted request for action. In some embodiments, a request for action is a task and/or a ToDo. In various embodiments, a task is a ToDo.

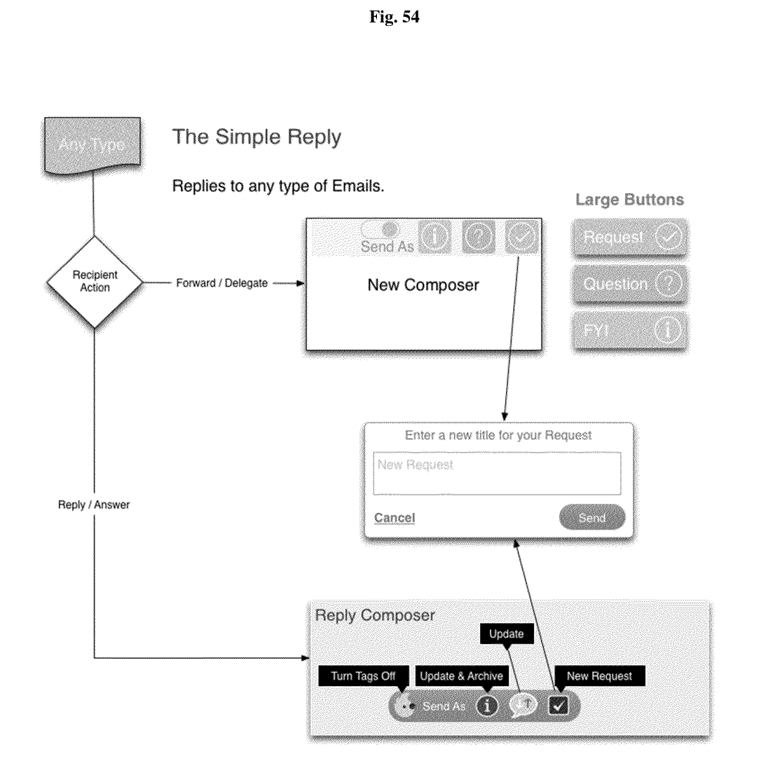

As a non-limiting example, FIG. 54 depicts a Simple Reply Composer. In some embodiments, changing the subject line starts a new communication life cycle. In some embodiments, when the user closes the communication life cycle they use an FYI to update and archive the communication life cycle. In various embodiments, using the FYI to update and archive the communication life cycle occurs at the same time as closing the communication life cycle. In some embodiments, when the user creates a new request, for example a request for action, in response to a received electronic communication, the user will be prompted to provide a suitable title, for example in the Subject line, for the new request. In various embodiments, the user will reply and/or update the same communication life cycle using the “Update” button, which in some embodiments indicates the user is expecting information in response to their reply to be received.

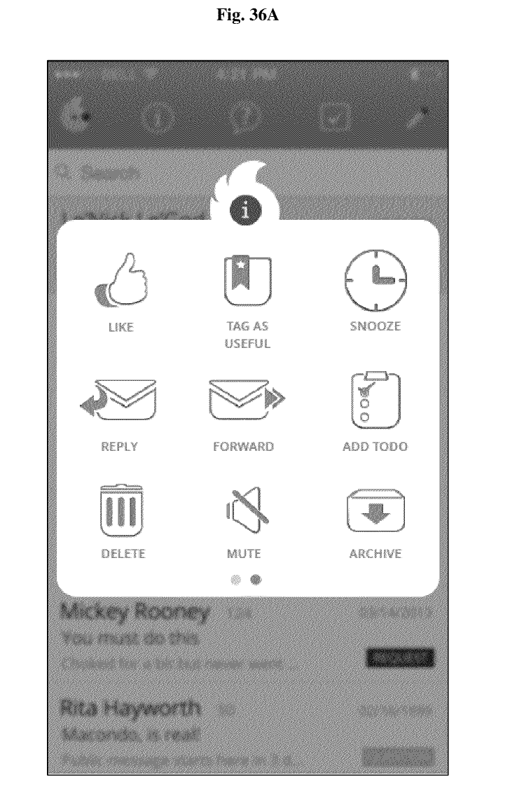

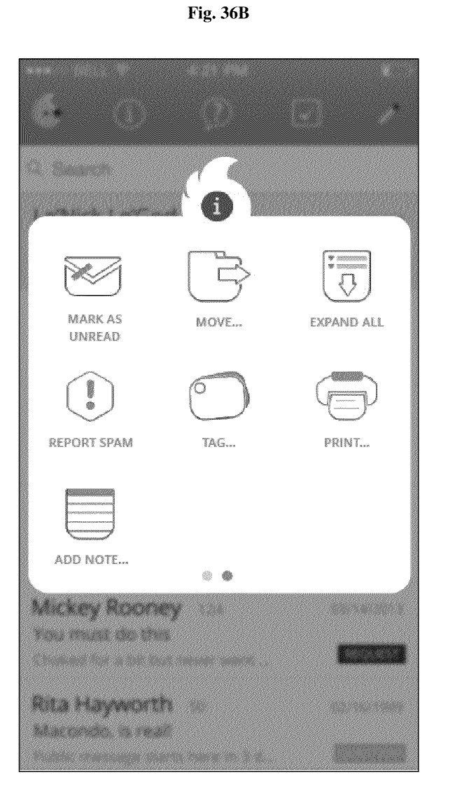

As depicted in a non-limiting example in FIG. 35, for example, the responding module comprises an interactive interface element on the receipt interface to display an FYI overlay. In some embodiments, the interactive interface element is displayed using a swiping interaction by the user. For example, a user placing his finger on the screen of a mobile device (e.g., smart phone, tablet computer, laptop, or smart watch) over the received electronic communication and swiping his finger from left to right. In some embodiments, as depicted in FIG. 36A, the FYI overlay comprises one or more of i) an interface element to like the electronic communication, ii) an interface element to mark the electronic communication as useful, iii) an interface element to snooze the electronic communication, iv) an interface element to respond to the electronic communication v) an interface element to forward the electronic communication, vi) an interface element to generate a Self ToDo based on the electronic communication, vii) an interface element to delete the electronic communication viii) an interface element to mute the electronic communication, or ix) an interface element to archive the electronic communication, and wherein based on the selection of an interface element the electronic communication metadata is updated or another interface is presented. In some embodiments, forwarding or responding to the FYI electronic communication generates a new communication life cycle using the New Composer.

In various embodiments, liking the electronic communication updates the metadata of the electronic communication and/or sends an additional electronic communication to the sender and/or all other recipients of the communication life cycle. In some embodiments, snoozing the electronic communication results in the electronic communication being marked as read and hidden until the date and/or time selected to snooze occurs on which the electronic communication will appear as unread and not hidden. In some embodiments, forwarding and responding to the electronic communication starts a new communication life cycle and presents the compose interface to generate an electronic communication. In various embodiments, generating a Self ToDo based on the electronic communication, presents the Self ToDo interface. In various embodiments, muting the electronic communication will prevent future electronic communications of the communication life cycle, for example other FYIs, inquiries, and/or tasks, from being received. In some embodiments, muting the electronic communication will prevent future replies to the electronic communication from being received. In some embodiments, archiving the electronic communication saves the electronic communication.

In some embodiments, as depicted in FIG. 36B, the FYI overlay comprises one or more of i) an interface element to mark the electronic communication as unread, ii) an interface element to move the electronic communication to another electronic location, iii) an interface element to expand all sent and received electronic communications in a communication life cycle, iv) an interface element to report spam, v) an interface element to tag the electronic communication, vi) an interface element to print the electronic communication, vii) an interface element to add a personal note to the electronic communication.

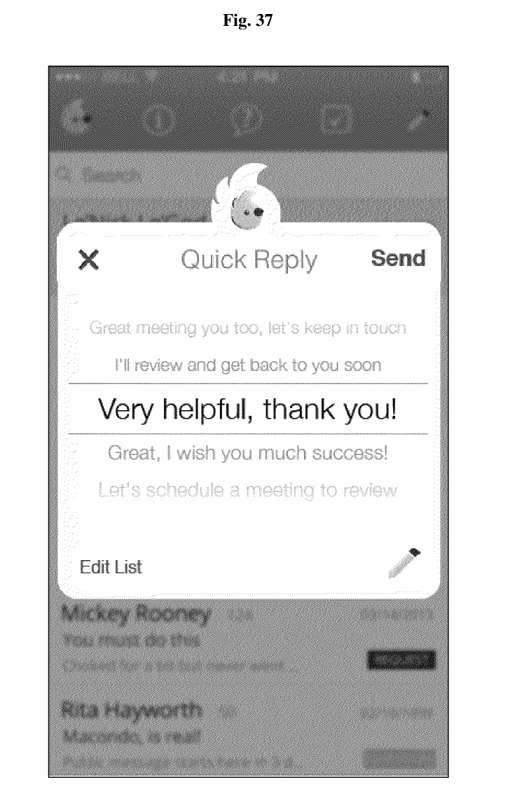

In various embodiments, selecting the Reply interface element of the FYI overlay displays a Quick Reply overlay, as depicted in a non-limiting example in FIG. 37. In some embodiments, selecting a response from the Quick Reply overlay sends the selected response to the sender and/or all other recipients of the electronic communication. In some embodiments, the metadata of the electronic communication is updated when a response is selected.

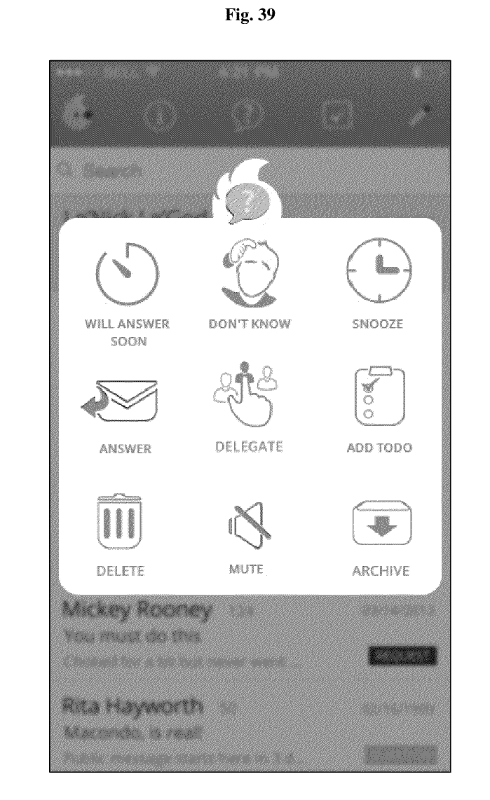

As depicted in a non-limiting example in FIG. 38, for example, the responding module comprises an interactive interface element on the receipt interface to display an inquiry response overlay. In some embodiments, the interactive interface element is displayed using a swiping interaction by the user. For example, a user placing his finger on the screen of a mobile device (i.e., smart phone, tablet computer, laptop, or smart watch) over the received electronic communication and swiping his finger from left to right. In some embodiments, as depicted in FIG. 39, the inquiry response overlay comprises one or more of i) an interface element to indicate a recipient will soon answer the inquiry, ii) an interface element to indicate a recipient does not know the answer, iii) an interface element to snooze the electronic communication, iv) an interface element to respond to the electronic communication, v) an interface element to delegate the electronic communication, vi) an interface element to generate a Self ToDo based on the electronic communication, vii) an interface element to delete the electronic communication, viii) an interface element to mute the electronic communication, or ix) an interface element to archive the electronic communication, and wherein based on the selection of an interface element the electronic communication metadata is updated or another is interface is presented. In some embodiments, a response to an inquiry uses the Answer Composer. In some embodiments, a response to an inquiry uses the Simple Reply Composer.

In some embodiments, snoozing the electronic communication results in the electronic communication being marked as read and hidden until the date and/or time selected to snooze occurs on which the electronic communication will appear as unread and not hidden. In some embodiments, responding to the electronic communication presents the compose interface to generate an electronic communication. In some embodiments, delegating the electronic communication presents the compose interface to generate an electronic communication. In some embodiments, generating a Self ToDo based on the electronic communication, presents the Self ToDo interface. In various embodiments, deleting delete the electronic communication updates the metadata of the electronic communication and/or sends an FYI electronic communication of the electronic communication to the sender and all other recipients to indicate the inquiry has been rejected. In various embodiments, muting the electronic communication will prevent future electronic communications of the communication life cycle, for example other FYIs, inquiries, and/or tasks, from being received. In some embodiments, muting the electronic communication will prevent future replies to the electronic communication from being received.

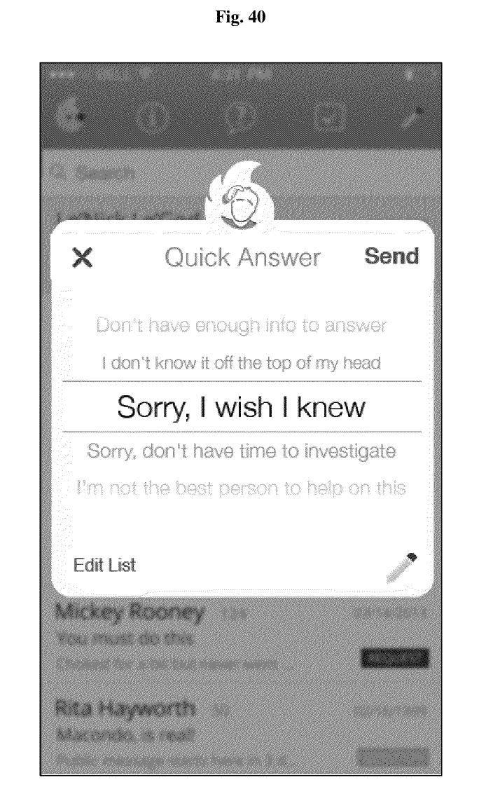

In some embodiments, selecting the interface element to indicate a recipient does not know the answer (i.e., the Don't Know interface element) presents a quick answer overlay as depicted in a non-limiting example in FIG. 40. In some embodiments the quick answer overlay comprises an interface to select a prepared response, and wherein selection of the prepared response sends a response electronic communication to the sender and all other recipients of the original electronic communication. In various embodiments, when a user selects a quick answer the metadata of the electronic communication is updated with the selected quick answer. In some embodiments, when a user selects a quick answer an electronic communication is sent to the sender and/or the other recipients of the original electronic communication.

In various embodiments, the systems, methods, devices and media described herein comprise a software module configured to provide an interface to edit a plurality of prepared responses, for example a prepared response to provide a quick answer. In some embodiments a request for action comprises an inquiry.

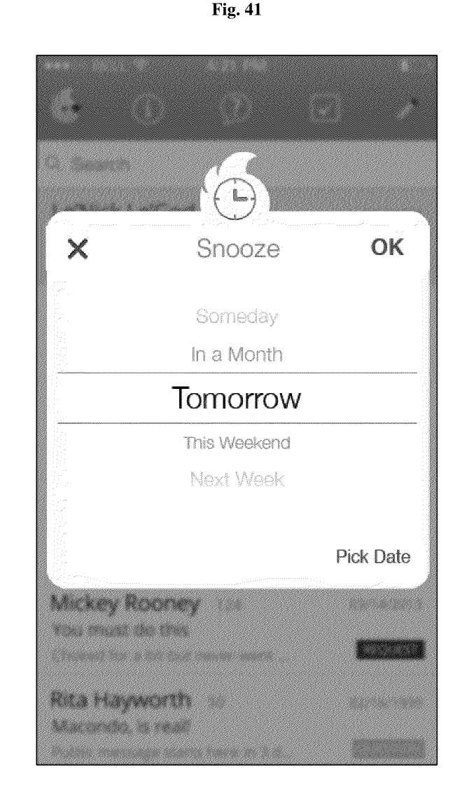

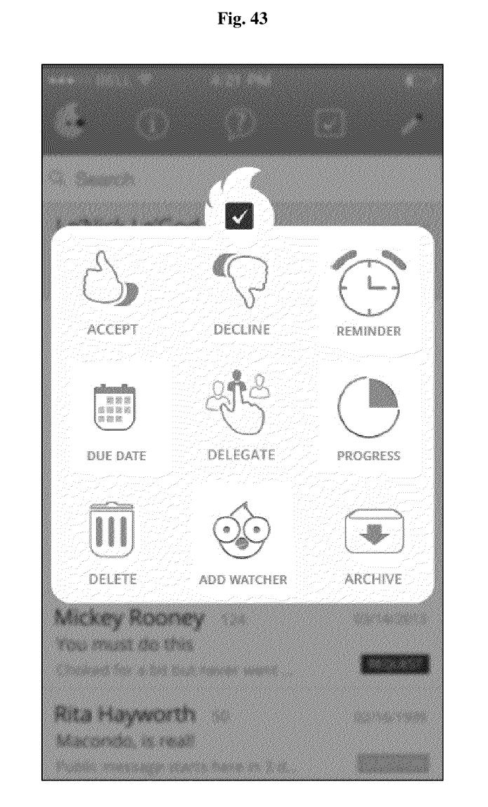

In various embodiments, selecting the interface element to snooze the electronic communication (i.e., the Snooze interface element) presents a snooze overlay, as depicted in a non-limiting example in FIG. 41. In some embodiments, the snooze overlay comprises an interface to select a snooze date or a snooze time, and wherein selection of the snooze date or the snooze time updates the electronic communication metadata. As depicted in a non-limiting example in FIG. 42, for example, the responding module comprises an interactive interface element on the receipt interface to display a task response overlay. In some embodiments, the interactive interface element is displayed using a swiping interaction by the user. For example, a user placing his finger on the screen of a mobile device (i.e., smart phone, tablet computer, laptop, or smart watch) over the received electronic communication and swiping his finger from left to right. In some embodiments, as depicted in FIG. 43, the inquiry response overlay comprises one or more of i) an interface element to accept the task, ii) an interface element to decline the task, iii) an interface element to add a reminder to the task, iv) an interface element to set a due date for the task, v) an interface element to delegate the task, vi) an interface element to update the progress of completing the task, vii) an interface element to delete the task, viii) an interface element to add a watcher to the task, ix) an interface element to archive the electronic communication, and the electronic communication metadata is updated or another is interface is presented when the user selects an interface element. In some embodiments a request for action comprises a task. In some embodiments, a task is a ToDo. In some embodiments, replies to not yet accepted task electronic communications use the Accept Composer. In some embodiments, replies to accepted task electronic communications use the Update Composer. In some embodiments, a response to an accepted task uses the Answer Composer. In some embodiments, a response an accepted task uses the Simple Reply Composer.

In some embodiments, delegating the electronic communication presents the compose interface to generate an electronic communication. In various embodiments, deleting the electronic communication updates the metadata of the electronic communication and/or sends an FYI electronic communication of the electronic communication to the sender and all other recipients to indicate the inquiry has been rejected. In various embodiments, adding a watcher to the electronic communication presents the Self ToDo interface such that a watcher can be added. In some embodiments, archiving the electronic communication saves the electronic communication.

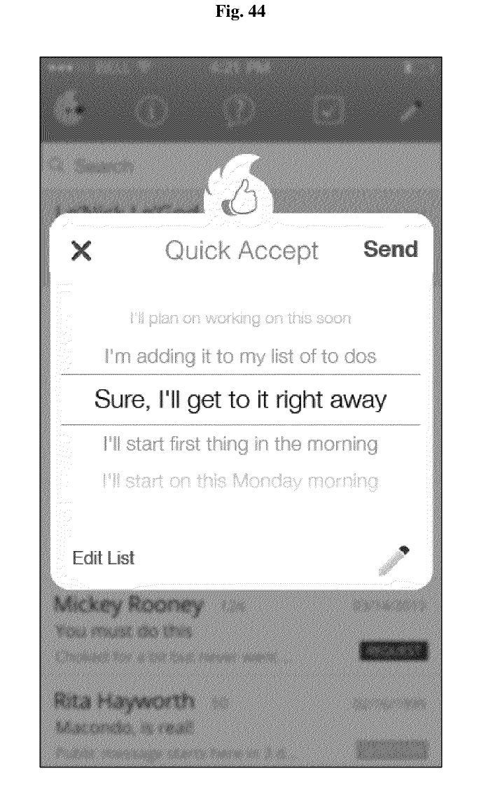

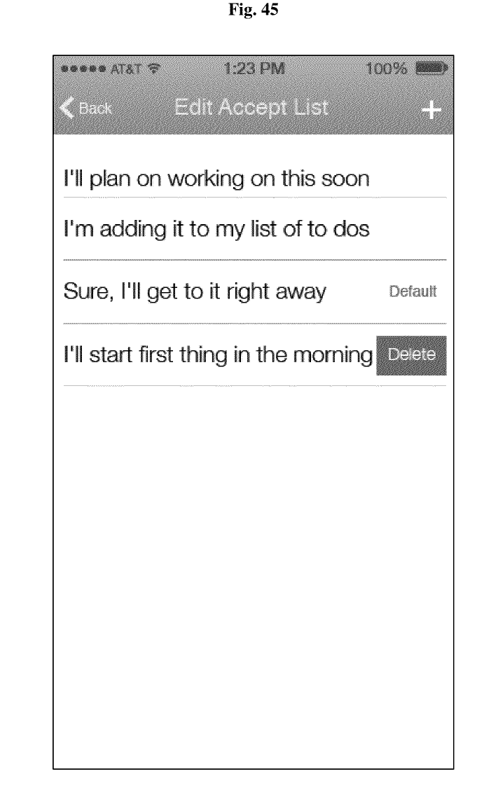

In some embodiments, selecting the accept the task interface element (i.e., the Accept interface element) presents a quick accept overlay, as depicted in a non-limiting example in FIG. 44. In some embodiments, the quick accept overlay provides an interface to select a prepared response, and wherein selection of a prepared response sends a response electronic communication to the sender and all other recipients of the original electronic communication. In some embodiments, selection of a prepared response updated the metadata of the electronic communication. In various embodiments, as depicted in a non-limiting example in FIG. 45, the systems, methods, devices and media described herein comprise a software module configured to provide an interface to edit a plurality of prepared responses, for example a prepared response to accept a task.

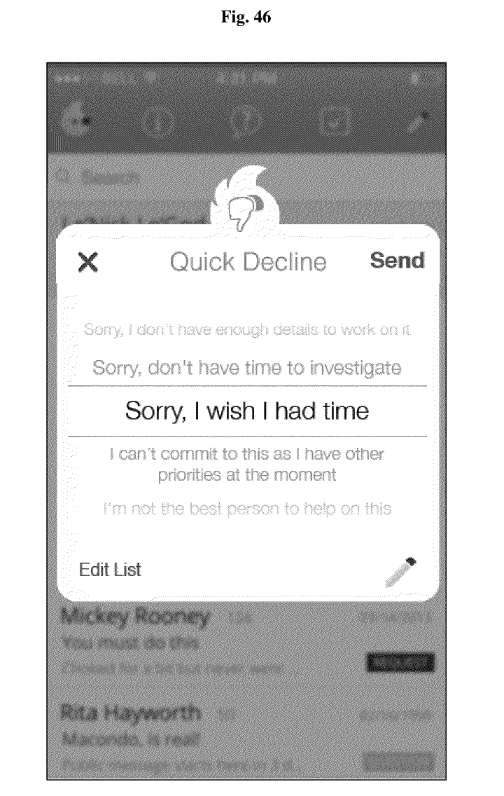

In some embodiments, selecting the decline the task interface element (i.e., the Decline interface element) presents a quick decline overlay, as depicted in a non-limiting example in FIG. 46. In some embodiments, the quick decline overlay provides an interface to select a prepared response, and wherein selection of a prepared response sends a response electronic communication to the sender and all other recipients of the original electronic communication. In some embodiments, selection of a prepared response updates the metadata of the electronic communication. In various embodiments, the systems, methods, devices and media described herein comprise a software module configured to provide an interface to edit a plurality of prepared responses, for example a prepared response to decline a task.

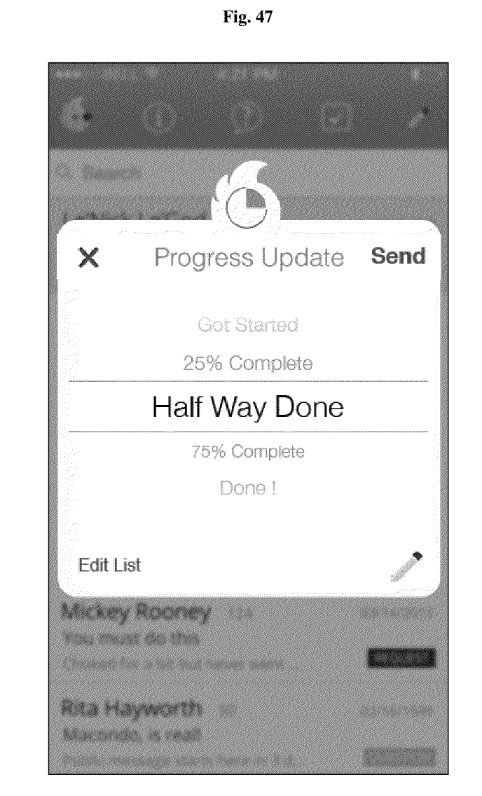

In some embodiments, selecting the interface element to update the progress of completing the task (i.e., the Progress interface element) presents a progress update overlay, as depicted in a non-limiting example in FIG. 47. In some embodiments, the progress update overlay comprises an interface to select a percent complete, and wherein selection of the percent complete updates the electronic communication metadata. In some embodiments, the progress update overlay comprises an interface to select a percent complete, and wherein selection of the percent complete results in an FYI electronic communication indicating the percent complete being sent to the sender and/or other recipients of the original electronic communication.

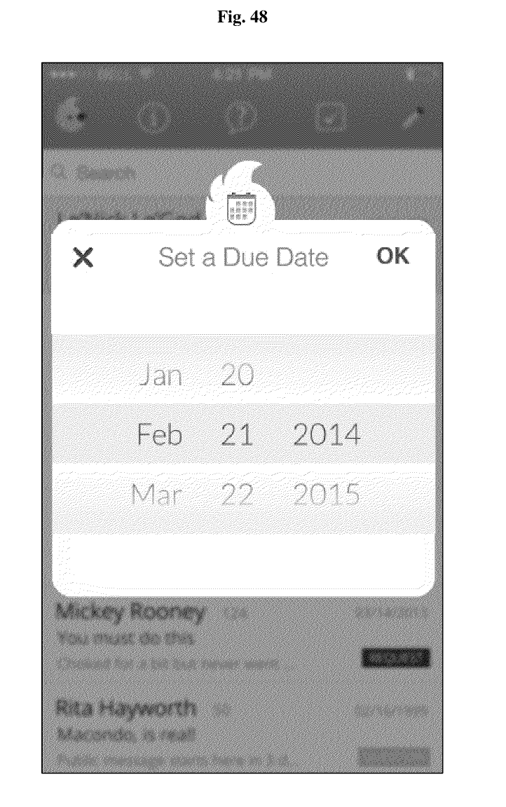

In some embodiments, the systems, methods, media, and platforms described herein comprise a software selecting module configured to provide a due date overlay, for example a set a due date overlay. In some embodiments, selecting the interface element to set a due date (i.e., the Due Date interface element) presents a set a due date overlay, as depicted in a non-limiting example in FIG. 48. In some embodiments, the set a due date overlay comprises one or more interface elements to select a due date, and wherein selection of the date updates the electronic communication metadata. In some embodiments, the set a due date overlay comprises one or more interface elements to select a due date, and wherein selection of the date results in an FYI electronic communication indicating the due date being sent to the sender and/or other recipients of the original electronic communication.

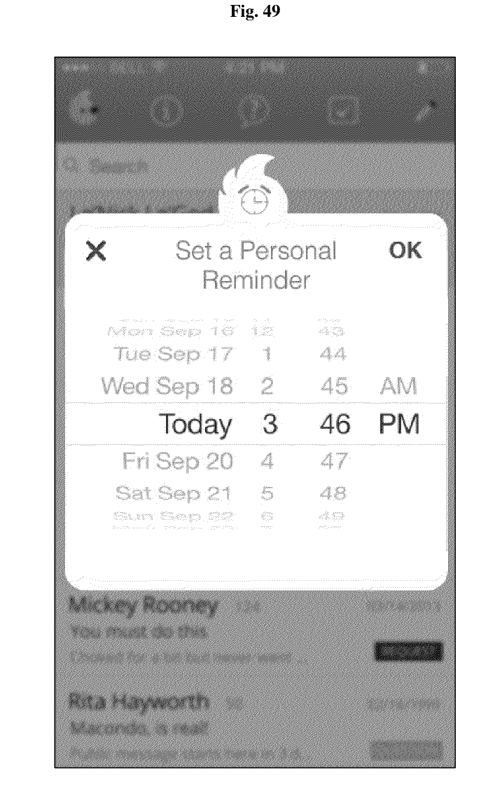

In some aspects, the systems, methods, media, and platforms described herein comprise a software selecting module configured to provide a reminder overlay configured to allow a sender of an electronic communication to set a reminder date and/or time for an electronic communication. In some embodiments, selecting the interface element to set a reminder (i.e., the Reminder interface element) presents a set a personal reminder overlay, as depicted in a non-limiting example in FIG. 49. In some embodiments, the set a personal reminder overlay comprises one or more interface elements to set a personal reminder date and/or time, and wherein selection of the date and time updates the electronic communication metadata.

In some aspects any one of the FYI overlay, the inquiry overlay, the task overlay, and/or a user-generated overlay comprises one or more of i) an interface element to mute the communication life cycle such that future electronic communications in the communication life cycle will not be communicated to the user, ii) an interface element to tag the electronic communication as useful and archive the electronic communication, iii) an interface element to create a task and/or a ToDo, which creates a task and/or a ToDo communication life cycle based on the received electronic communication, iv) an interface element to display a comment interface such that the user can add a personal note to the electronic communication, and v) a tag interface element to tag the electronic communication.

### Parsing and Updating Module

In some aspects the systems, methods, media and platforms described herein comprise a server comprising a store and a server processor configured to provide a server application comprising: a software receiving module configured to receive and store the electronic communication; a software parsing module configured to parse and store the electronic communication metadata, wherein the metadata comprises the tag and one or more of: identification information of a user sending the electronic communication, identification information of a user receiving the electronic communication, a request for action due date, a request for action completion date, a dependency between more than one request for action, and a dependency between more than one user, a dependency between more than one electronic communication; a software updating module configured to update the communication life cycle when the response to the request for action electronic communication is sent, the response comprising one or more of the delegation of the request for action and the percent complete, and wherein the update is stored in the electronic communication metadata; and a software transmitting module configured to transmit the updated electronic communication metadata to the client processor. In some embodiments, a dependency comprises a relationship between one electronic communication and all related forwarded, delegated, complete, and/or deleted electronic communications. In some embodiments, a dependency comprises a status.

In some aspects the systems, methods, media and platforms described herein comprise a server comprising a store and a server processor configured to provide a server application comprising: a software storing module configured to receive and store the electronic communication; a software parsing module configured to parse and store the electronic communication metadata, wherein the metadata comprises the tag and one or more of: identification information of a user sending the electronic communication, identification information of a user receiving the electronic communication, a task due date, a task completion date, a dependency between more than one task, a dependency between more than one inquiry, and a dependency between more than one user; a software module configured to update the communication life cycle when the response to the task electronic communication is sent or the response to the inquiry electronic communication is sent, the response comprising one or more of the delegation of the task and the percent complete, and wherein the update is stored in the electronic communication metadata; and a software transmitting module configured to transmit the updated electronic communication metadata to the client processor.

In some embodiments, the server comprises: a software tracking module configured to track the communication life cycle by storing a status of the request for action, task and/or inquiry, the status of the request for action, task and/or inquiry extracted from the electronic communication metadata; and a software update transmission module configured to transmit the status to the client processor. In various embodiments, the status comprises one or more of a percent completion, a delegation of at least part of the task, ownership of the task, ownership of the inquiry, acceptance of the task, declining of the task, the request for action start date, the request for action due date, the request for action completion date, the task start date, the task due date, the task completion date, and a priority for completion of the task or the inquiry. In some embodiments, the software tracking module is configured to track the communication life cycle by storing a plurality of statuses between a plurality of tasks, the plurality of statuses defining a hierarchy of the plurality of tasks. In various embodiments, the software tracking module is configured to track the communication life cycle by storing a plurality of statuses between a plurality of inquiries, the plurality of statuses defining a hierarchy of the plurality of inquiries. In some embodiments, the software tracking module is configured to track the communication life cycle by storing a plurality of statuses between a plurality of tasks and a plurality of inquiries, the plurality of statuses defining a hierarchy of the plurality of tasks and the plurality of inquiries. In some embodiments, a status is a dependency.

In various embodiments, the client processor comprises a software receiving module configured to receive the status from the server and update the metadata of the electronic communication with the status. In some embodiments, the client processor comprises a software displaying module configured to parse the metadata and display the status of the task, the inquiry, or the task and the inquiry. In some embodiments, the client processor further comprises a software reporting module configured to generate a report based on one or more of the classification data and the metadata, the report comprising one or more of a delegation chart, a list, a Gantt chart, a timeline chart, and a calendar. In various embodiments, the report comprises a first status of a first task, the first status comprising a percent complete. In various embodiments, the report comprises a second status of a second task, the second task related to the first task, dependent on the first task, delegated from the first task, or a combination thereof. In some embodiments, the second status comprises a percent complete. In some embodiments, the software displaying module is the software reporting module. In some embodiments, the software displaying module communicates with the software reporting module.

In some embodiments, the server application comprises a software module configured to determine whether the inquiry has been completed and/or whether the task has been completed. In various embodiments, an inquiry is complete by responding to the inquiry. In some embodiments, the task is complete when it is updated to be 100% complete. In various embodiments, when the task or inquiry is complete, as determined by the software module configured to determine whether the inquiry has been completed and/or whether the task has been completed, all electronic communications belonging to the complete communication life cycle are placed in a generic location, for example an “all mail” folder. In other words, the systems, methods, media and platforms described herein monitor all electronic communications belonging to the communication life cycle in order to determine whether the communication life cycle is complete. In some embodiments, once an electronic communication of a communication life cycle is complete, rather than the entire communication life cycle being complete, the electronic communication of the communication life cycle placed in the a generic location, for example an “all mail” folder.

In some aspects, an electronic communication comprises one or more tags that are suggested by the sender. The suggested tags, in some embodiments are changed by the recipient, for example by using the tag interface element. In some embodiments, the tag interface element is displayed on an overlay, for example an FYI overlay, an inquiry overlay, a task overlay, or a request for action overlay. In some embodiments, the compose interface is then displayed to tag the electronic communication. In various embodiments, a menu, for example a drop down menu and/or an overlay menu, is displayed to allow selection of a new tag. In various embodiments, after the tag of the electronic communication is changed, the server updates the metadata of the electronic communication. In some embodiments, the updated metadata is transmitted to the sender and all recipients of the original electronic communication. In various embodiments, after the tag of the electronic communication is changed, the server sends an electronic communication, for example an FYI electronic communication, indicating the tag has been changed, the FYI electronic communication sent to all recipients of the original electronic communication. As a non-limiting example, sender might send an inquiry electronic communication as asking “How much was spent on office supplies?” This message will arrive at the recipient as an inquiry. However, the recipient might not have that number readily available and have to do some work to calculate it. In this case the recipient changes the tag from an inquiry to a task and/or a ToDo so he can work on it when he gets back to his desk. In some embodiments, swiping a message in the receipt interface to the right or left and/or selection of “more” from the menu will allow the recipient to change the type of message.

In various embodiments, after the tag of the electronic communication is changed and the server updates the metadata, the metadata of the electronic communication on the client application will be updated from the server and the electronic communication will be displayed in the appropriate receipt interface selection. For example, changing the tag from an inquiry to a task will cause the message to no longer be displayed when the interactive interface element to display electronic communications tagged as an inquiry is selected but will appear when the interactive interface element to display electronic communications tagged as a task is selected. In some embodiments, in order to not confuse the sender, the metadata of the electronic communication for the sender does not cause the electronic communication to change where it is displayed, but rather a status update is provided for it, e.g., “Pending” or “In Progress.”

In some embodiments, a status of an electronic communication is changes by a sender's action or recipient's action. In various embodiments, when the sender causes the status to change, the recipient's, or more than one recipient's, status is also changed. In various embodiments, when the recipient causes the status to change the sender's is also changed. As a non-limiting example, when a recipient opens an electronic communication, the status changes from new to read for the recipient. This change in status is transmitted to the server and is stored in the electronic communication metadata. Then based on the electronic communication metadata, the electronic communication is marked as “Read” for the sender. In some embodiments, not all statuses are shared. As a non-limiting example, the table below shows various embodiments of shared statuses, personal statuses, the composer used to change the status, and whether a change in the status impacts previously sent electronic communications (ECs).

TABLE 1

| | | Impact | | |
|---|---|---|---|---|
| | Shared/ | Previous | | Composer |
| Status | Personal | ECs | Description | Type |
| Like | Shared | No | FYI marked manually as Useful by recipient, also archived | n/a |
| Useful | Personal | No | Any EC can be marked useful for future reference, | n/a |
| | | | also archived | |
| Mute | Personal | Yes/No | Mute all replies/updates to electronic communication | n/a |
| Read Later | Personal | No | FYIs marked by recipient to read later | n/a |
| Answered | Shared | Yes | Inquiry ECs that have been answered | New |
| Unresolved | Shared | Yes | Inquiry ECs that were marked as “I don't know” | Answer |
| | | | Once an Inquiry is marked as Answered it cannot be changed. | |
| Accepted | Shared | No | Tasks that have been accepted by recipient | Update |
| | | | If a Due Date is assigned or changed, this flag is reset (i.e., | |
| | | | turns). | |
| Rejected | Shared | Yes | A Task that has been rejected by recipient | Update |
| Self To Do | Personal | No | An EC that was marked as Task by the recipient | Update |
| (Self Task) | | | | |
| Partial | Both | Yes | Tasks marked with a specific percentage as partially | Update |
| | | | completed | |
| Completed | Both | Yes | Tasks that have been marked as 100% completed | Update |
| Commented | Both/ | No | Any EC that got some personal note attached to it by | n/a |
| | Personal | | the user | |
| Due Date | Both | No | Any Task that has a Due Date -- No Due Date for FYIs or | Update |
| | | | Inquiries | |
| Overdue | Both | No | Any Task that is passed the Due Date. Applies only to Personal | Update |
| | | | or Accepted Tasks | |
| Canceled | Shared | Yes | Cancel an Inquiry or Task that went out already. | New |
| Unread (auto) | Personal | No | ECs that have not been opened or read by the recipient | n/a |
| Read (auto) | Personal | No | ECs that have opened or read by the recipient | n/a |

### Notification

In some aspects, the systems, methods, media, and platforms described herein comprise a software module configured to notify the user when the electronic communication is received, the notification comprising audible and/or tactile notification. In some embodiments, the notification is provided when a quick response is required by the electronic communication. In some embodiments, notification is provided when the request for action electronic communication is received and the request for action electronic communication comprises a due date.

The computer-implemented electronic communication system for improving electronic communication based workflow management of any one or more of the embodiments listed above, wherein the system is configured to be run using a mobile device comprising a cellular phone, a smart phone, a tablet computer, and a smart watch.

The computer-implemented electronic communication system for improving electronic communication based workflow management of any one or more of the embodiments listed above, wherein the recipient selects one or more electronic communication types for which notification is provided. In some embodiments, the electronic communication type comprises one or more of a request for action, a task, a ToDo, an inquiry, a request for information, and/or an FYI. In some embodiments, the recipient selects one or more tags comprising a request for action, a task, a ToDo, a request for information, an inquiry and/or an FYI for which the recipient will receive a notification when an electronic communication comprising the one or more tags is received. In some embodiments, the recipient selects one or more electronic communication types comprising a request for action, a task, a ToDo, a request for information, an inquiry and/or an FYI for which the recipient will receive a notification when an electronic communication comprising the selected type(s) is received. In some embodiments the recipient selects to receive notifications when an electronic communication comprising a request for action tag is received. In some embodiments, the electronic communication type is a request for action electronic communication. In some embodiments, a request for action comprises a task, a ToDo, a request for information and/or an inquiry. In some embodiments the recipient selects to receive notifications when an electronic communication comprising an FYI tag is received. In various embodiments, the recipient selects the tags and/or electronic communication types for which notification will be provided using an interface comprising one or more interactive interface elements. In some embodiments, the recipient selects more than one tag and/or electronic communication type for which notifications will be provided.

### Digital Processing Device

In some embodiments, the platforms, systems, media, and methods described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art. In some embodiments, the digital processing device is a computational device, an external and/or any other device described herein.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Server Configuration

In some embodiments, a suitable server configuration includes 1, 2, 3, 4, 5, 6, 7, 8, 9, 10, 20, 30, 40, 50, 60, 70, 80, 90, 100, 200, 500, 1000 or more servers, one or more server farms, and cloud-based server resource allocation systems. In some embodiments, the servers are co-located. In some embodiments, the servers are located in different geographical locations. In some embodiments the servers are housed in the same rack. In some embodiments, the servers are housed in multiple racks. In some embodiments, the multiple racks are in the same geographic region. In some embodiments the racks are in different geographic regions. In some embodiments, the server is or a plurality of servers employ a software framework such as Hadoop, Google MapReduce, HBase, and/or Hive, for storage and large-scale processing of data-sets on clusters of hardware.

### Non-Transitory Computer Readable Storage Medium

In some embodiments, the platforms, systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™ and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web applications software framework such as Hadoop, Google MapReduce, HBase, and/or Hive, for storage and/or large-scale processing of data-sets on clusters of hardware is employed. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™ and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Swift, Java™, Javascript, Pascal, Object Pascal, Python™ Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, Google Play, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, Swift, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of electronic communication information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices. Persons of ordinary skill in the art will recognize that the methods, platforms, systems and media described herein, in some embodiments, require big data storage and analysis platforms.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A computer-implemented electronic communication system for improving electronic communication based workflow management comprising a client processor configured to provide a client application comprising:
a) a first software module configured to provide a compose interface configured to receive user input to generate a communication life cycle by composing an electronic communication and assigning the electronic communication one or more tags from a plurality of tags, wherein a first tag indicates a request for action and a second tag indicates an FYI, wherein the compose interface comprises one or more interface elements that tag and send the electronic communication to a recipient, and wherein the one or more tags are stored in electronic communication metadata;
b) a second software module configured to receive the electronic communication, identify an electronic communication type based on the electronic communication metadata, and provide a receipt interface comprising a first interface element corresponding to the first tag and a second interface element corresponding to the second tag, wherein selection of the first interface element displays only a request for action electronic communication and selection of the second interface element displays only an FYI electronic communication;
c) a third software module configured to provide an interface to respond to the electronic communication, wherein a response to the request for action electronic communication comprises one or more of accepting the request for action, declining the request for action, a response to the request for action, a delegation of the request for action, and a percent complete, and wherein a response to an FYI electronic communication requires generation of another communication life cycle; and
d) a fourth software module configured to display or notify the user when the electronic communication is received, the notification comprising visual notification, audible notification, tactile notification, or a combination thereof, wherein the recipient selects one or more electronic communication types for which notification is provided;
whereby using the computer-implemented electronic communication system to generate the electronic communication, receive the electronic communication, and respond to the electronic communication improves electronic communication based workflow management.

2. The computer-implemented electronic communication system for improving electronic communication based workflow management of claim 1, further comprising a server comprising a store and a server processor configured to provide a server application comprising:
a) a first software module configured to receive and store the electronic communication;
b) a second software module configured to parse and store the electronic communication metadata, wherein the metadata comprises the tag and one or more of: identification information of a user sending the electronic communication, identification information of a user receiving the electronic communication, a request for action due date, a request for action completion date, a dependency between more than one request for action, and a dependency between more than one user;
c) a third software module configured to update the communication life cycle when the response to the request for action electronic communication is sent, the response comprising one or more of the delegation of the request for action and the percent complete, and wherein the update is stored in the electronic communication metadata; and
d) a fourth software module configured to transmit the updated electronic communication metadata to the client processor.

3. The computer-implemented electronic communication system for improving electronic communication based workflow management of claim 1, wherein the electronic communication type comprises one or more of a request for action, a task, a ToDo, an inquiry, a request for information, and an FYI.

4. The computer-implemented electronic communication system for improving electronic communication based workflow management of claim 1, wherein the electronic communication comprises an email, a text message, an instant message, or a voice message.

5. The computer-implemented electronic communication system for improving electronic communication based workflow management of claim 1, wherein the system is configured to be run using a mobile device comprising a cellular phone, a smart phone, a tablet computer, and a smart watch.

6. The computer-implemented electronic communication system for improving electronic communication based workflow management of claim 1, wherein the client application comprises a fifth software module configured to provide a due date selection interface.

7. The computer-implemented electronic communication system for improving electronic communication based workflow management of claim 1, wherein the client application comprises a fifth software module configured to provide a reminder interface configured to allow a sender of an electronic communication to set a reminder date for a sent electronic communication.

8. The computer-implemented electronic communication system for improving electronic communication based workflow management of claim 1, wherein the client application comprises a fifth software module configured to provide an interface to display one or more due items, and wherein the one or more due items are displayed with corresponding due dates.

9. The computer-implemented electronic communication system for improving electronic communication based workflow management of claim 8, wherein the interface to display due items is a calendar, a grid, or a list.

10. The computer-implemented electronic communication system for improving electronic communication based workflow management of claim 1, wherein the client application comprises a fifth software module configured to provide an FYI overlay comprising one or more of i) an interface element to like the electronic communication, ii) an interface element to mark the electronic communication as useful, iii) an interface element to snooze the electronic communication, iv) an interface element to respond to the electronic communication v) an interface element to forward the electronic communication, vi) an interface element to generate a Self ToDo based on the electronic communication, vii) an interface element to delete the electronic communication viii) an interface element to mute the electronic communication, or ix) an interface element to archive the electronic communication, and wherein based on the selection of an interface element the electronic communication metadata is updated or another interface is presented.

11. The computer-implemented electronic communication system for improving electronic communication based workflow management of claim 3, wherein the client application comprises a fifth software module configured to provide an inquiry response overlay comprising one or more of i) an interface element to indicate a recipient will soon answer the inquiry, ii) an interface element to indicate a recipient does not know the answer, iii) an interface element to snooze the electronic communication, iv) an interface element to respond to the electronic communication, v) an interface element to delegate the electronic communication, vi) an interface element to generate a Self ToDo based on the electronic communication, vii) an interface element to delete the electronic communication, viii) an interface element to mute the electronic communication, or ix) an interface element to archive the electronic communication, and wherein based on the selection of an interface element the electronic communication metadata is updated or another is interface is presented.

12. The computer-implemented electronic communication system for improving electronic communication based workflow management of claim 11, wherein selection of the interface element to indicate a recipient does not know the answer presents a quick answer overlay comprising an interface to select a prepared response, and wherein selection of the prepared response sends a response electronic communication.

13. The computer-implemented electronic communication system for improving electronic communication based workflow management of claim 11, wherein selection of the interface element to snooze the electronic communication presents a snooze overlay comprising an interface to select a snooze date or a snooze time, and wherein selection of the snooze date or the snooze time updates the electronic communication metadata.

14. The computer-implemented electronic communication system for improving electronic communication based workflow management of claim 3, wherein the client application comprises a fifth software module configured to provide a task response overlay comprising one or more of i) an interface element to accept the task, ii) an interface element to decline the task, iii) an interface element to add a reminder to the task, iv) an interface element to set a due date for the task, v) an interface element to delegate the task, vi) an interface element to update the progress of completing the task, vii) an interface element to delete the task, viii) an interface element to add a watcher to the task, ix) an interface element to archive the electronic communication, and the electronic communication metadata is updated or another is interface is presented when the user selects an interface element.

15. The computer-implemented electronic communication system for improving electronic communication based workflow management of claim 14, wherein selection of the accept the task interface element presents a quick accept overlay comprising an interface to select a prepared response, and wherein selection of a prepared response sends a response electronic communication.

16. The computer-implemented electronic communication system for improving electronic communication based workflow management of claim 14, wherein selection of the interface element to decline the task presents a quick decline overlay comprising an interface to select a prepared response, and wherein selection of a prepared response sends a response electronic communication.

17. The computer-implemented electronic communication system for improving electronic communication based workflow management of claim 14, wherein selection of the interface element to update the progress of completing the task presents a progress update overlay comprising an interface to select a percent complete, and wherein selection of the percent complete updates the electronic communication metadata.

18. The computer-implemented electronic communication system for improving electronic communication based workflow management of claim 14, wherein selection of the interface element to set a due date presents a set a due date overlay comprising an interface to select the due date by a recipient, and wherein selection of the date updates the electronic communication metadata.

19. The computer-implemented electronic communication system for improving electronic communication based workflow management of claim 1, wherein the client application comprises a fifth software module configured to provide a chart interface, wherein the chart interface is configured to display a graphical representation of the communication life cycle.

20. The computer-implemented electronic communication system for improving electronic communication based workflow management of claim 19, wherein the graphical representation comprises a sent request for action electronic communication, the delegation of the request for action, and the percent complete of the request for action.

21. (canceled)

22. (canceled)

23. The computer-implemented electronic communication system for improving electronic communication based workflow management of claim 1, wherein the client application comprises a fifth software module configured to provide a due interface to display the electronic communication comprising a due-date within a user-defined time period relative to the date in which the system promotes the electronic communication to the due interface, and wherein a plurality of electronic communications are displayed according to their completion deadline.

24. The computer-implemented electronic communication system for improving electronic communication based workflow management of claim 23, wherein the user-defined time period is in the future or the past relative to the date in which the system promotes the electronic communication to the due interface.

25. The computer-implemented electronic communication system for improving electronic communication based workflow management of claim 24, wherein a sent and a received electronic communication are displayed.

26. The computer-implemented electronic communication system for improving electronic communication based workflow management of claim 1, wherein the compose interface is further configured to allow the user to select a watcher, wherein the watcher will receive the electronic communication, all replies to the electronic communications, and updates to the electronic communication.

27. The computer-implemented electronic communication system for improving electronic communication based workflow management of claim 26, wherein the compose interface is configured to permit selection of the watcher after the electronic communication is sent.

28. A computer-implemented electronic communication system for improving electronic communication based workflow management comprising a client processor configured to provide a client application comprising:
a) a first software module configured to provide a compose interface configured to receive user input to generate a communication life cycle by composing an electronic communication and assigning the electronic communication one or more tags from a plurality of tags, wherein a first tag indicates a task, a second tag indicates an inquiry, and a third tag indicates an FYI, wherein the compose interface comprises one or more interface elements that tag and send the electronic communication to a recipient, and wherein the one or more tags are stored in the metadata of the electronic communication;
b) a second software module configured to receive the electronic communication, identify the electronic communication type based on the electronic communication metadata, and provide a receipt interface comprising a first interface element corresponding to the first tag, a second interface element corresponding to the second tag, and a third interface element corresponding to the third tag, wherein selection of the first interface element displays only a task electronic communication, selection of the second interface element displays only an inquiry electronic communication, and selection of the third interface element displays only an FYI electronic communication;
c) a third software module configured to provide an interface to respond to the electronic communication, wherein a response to a task electronic communication comprises one or more of accepting the task, declining the task, indicating an amount completion of the task, and a delegation of the task to another recipient, and a percent complete, and wherein a response to an inquiry electronic communication comprises one or more of responding to the inquiry, forwarding the inquiry to another recipient, and deleting the inquiry, and wherein a response to an FYI electronic communication requires generation of another communication life cycle; and
d) a fourth software module configured to display or notify the user when the electronic communication is received, the notification comprising visual notification, audible notification, tactile notification, or a combination thereof, wherein the recipient selects one or more electronic communication types for which notification is provided;
whereby using the computer-implemented electronic communication system to generate the electronic communication, receive the electronic communication, and respond to the electronic communication improves electronic communication based workflow management.

29. The computer-implemented electronic communication system for improving electronic communication based workflow management of claim 28, further comprising a server comprising a store and a server processor configured to provide a server application comprising:
a) a first software module configured to receive and store the electronic communication;
b) a second software module configured to parse and store the electronic communication metadata, wherein the metadata comprises the tag and one or more of: identification information of a user sending the electronic communication, identification information of a user receiving the electronic communication, a task due date, a task completion date, a dependency between more than one task, a dependency between more than one inquiry, and a dependency between more than one user;
c) a third software module configured to update the communication life cycle when the response to the task electronic communication is sent or the response to the inquiry electronic communication is sent, the response comprising one or more of the delegation of the task and the percent complete, and wherein the update is stored in the electronic communication metadata; and
d) a fourth software module configured to transmit the updated electronic communication metadata to the client processor.

30. (canceled)
